(19) United States
(12) Patent Application Publication
(10) Pub. No.: US 2016/0294892 A1
(43) Pub. Date: Oct. 6, 2016

(54) Storage Medium Storing Program, Server Apparatus, and Method of Controlling Server Apparatus

(71) Applicant: Brother Kogyo Kabushiki Kaisha, Nagoya-shi (JP)

(72) Inventor: Megumi Hata, Nagakute-shi (JP)

(21) Appl. No.: 15/071,946

(22) Filed: Mar. 16, 2016

(30) Foreign Application Priority Data
Mar. 30, 2015 (JP) 2015-068320

(51) Int. Cl. H04L 29/06

(52) U.S. Cl. CPC H04L 65/403

(57) ABSTRACT

A program for a teleconference causes, when executed, a server apparatus to perform operations including: a first receiving operation of receiving a first notification, through a communicator of the server apparatus connected to a network, from a first terminal apparatus out of a plurality of terminal apparatuses, a first authority being set to the first terminal apparatus, the first authority being one of authorities that are preliminarily set in the teleconference; a first determining operation of determining a transmission destination of the first notification received by the first receiving operation based on conference mode information related to a total number of the plurality of terminal apparatuses connecting to the teleconference, the transmission destination being at least one of the plurality of terminal apparatuses; and a first transmitting operation of transmitting the first notification from the communicator to the transmission destination determined by the first determining operation.

### CROSS REFERENCE TO RELATED APPLICATIONS

This application claims priority from Japanese Patent Application No. 2015-068320 filed Mar. 30, 2015. The entire content of the priority application is incorporated herein by reference.

### TECHNICAL FIELD

This disclosure relates to a storage medium storing a program executable by a computer that controls a server apparatus that executes a teleconference conducted by a plurality of terminal apparatuses. The disclosure also relates to a server apparatus and a method of controlling a server apparatus.

### BACKGROUND

Technology relating to a teleconference conducted through a network is proposed. For example, a video conference system is proposed. In this video conference system, a special function as a conference facilitator is added to a host terminal of a user who is selected as a host, and a special function as a participant terminal is added to a participant terminal of a user other than the host. In this video conference system, when a speaking request is inputted from a certain participant terminal, this request signal is transmitted to the host terminal. The host terminal determines which terminal has transmitted the speaking request signal. When the participant terminal having made the speaking request is determined, a function key area of a host screen becomes a speaking requester selection mode screen. The participant key of the terminal having made the speaking request blinks. The host specifies the terminal having made the speaking request by a key operation and so on of the input device, and inputs speaking permission. When the speaking permission is inputted on the host terminal, the permission signal is transmitted to all terminals. At the same time, each terminal starts capturing of image data of the speaker.

### SUMMARY

According to one aspect, this specification discloses a non-transitory computer-readable storage medium storing a program executable by a computer that controls a server apparatus configured to execute a teleconference conducted by a plurality of terminal apparatuses connected to a network. The program causes, when executed, the server apparatus to perform operations including: a first receiving operation of receiving a first notification, through a communicator of the server apparatus connected to the network, from a first terminal apparatus out of the plurality of terminal apparatuses, a first authority being set to the first terminal apparatus, the first authority being one of authorities that are preliminarily set in the teleconference; a first determining operation of determining a transmission destination of the first notification received by the first receiving operation based on conference mode information related to a total number of the plurality of terminal apparatuses connecting to the teleconference, the transmission destination being at least one of the plurality of terminal apparatuses; and a first transmitting operation of transmitting the first notification from the communicator to the transmission destination determined by the first determining operation.

According to another aspect, this specification also discloses a server apparatus configured to execute a teleconference conducted by a plurality of terminal apparatuses connected to a network. The server apparatus includes a communicator configured to connect to the network, a processor, and a memory storing instructions.

The instructions, when executed by the processor, cause the processor to perform: a first receiving operation of receiving a first notification, through the communicator, from a first terminal apparatus out of the plurality of terminal apparatuses, a first authority being set to the first terminal apparatus, the first authority being one of authorities that are preliminarily set in the teleconference; a first determining operation of determining a transmission destination of the first notification received by the first receiving operation based on conference mode information related to a total number of the plurality of terminal apparatuses connecting to the teleconference, the transmission destination being at least one of the plurality of terminal apparatuses; and a first transmitting operation of transmitting the first notification from the communicator to the transmission destination determined by the first determining operation.

According to still another aspect, this specification also discloses a method of controlling a server apparatus configured to execute a teleconference conducted by a plurality of terminal apparatuses connected to a network. The method includes: receiving a first notification, through a communicator of the server apparatus connected to the network, from a first terminal apparatus out of the plurality of terminal apparatuses, a first authority being set to the first terminal apparatus, the first authority being one of authorities that are preliminarily set in the teleconference; determining a transmission destination of the first notification based on conference mode information related to a total number of the plurality of terminal apparatuses connecting to the teleconference, the transmission destination being at least one of the plurality of terminal apparatuses; and transmitting the first notification from the communicator to the determined transmission destination.

### BRIEF DESCRIPTION OF THE DRAWINGS

Embodiments in accordance with this disclosure will be described in detail with reference to the following figures wherein:

FIG. 1 is a diagram showing an example of a teleconference system;

FIG. 2 is a table showing an example of a database managed by a server apparatus;

FIG. 3 is an example of a teleconference screen, wherein the upper part shows a state in which a shared document and face images are displayed and the lower part shows a state in which a face image is switched to a raise-hand image from the state of the upper part of FIG. 3 and a chat screen is also included;

FIG. 4 is a flowchart of a participant process;

FIG. 5 is a flowchart of a presenter process;

FIG. 6 is a flowchart of a host process;

FIG. 7 is a flowchart of a raise-hand displaying process;

FIG. 8 is a flowchart of a raise-hand display updating process;

FIG. 9 is a flowchart of a host raise-hand responding process;

FIG. 10 is a flowchart of an SOS displaying process;

FIG. 11 is a teleconference screen showing a state in which a face image is switched to an SOS image from the state of the upper part of FIG. 3;

FIG. 12 is a flowchart of an SOS display updating process;

FIG. 13 is a flowchart of a host SOS responding process;

FIG. 14 is a flowchart of a first part of a server process;

FIG. 15 is a flowchart of a second part of the server process;

FIG. 16 is a flowchart of a raise-hand determining process;

FIG. 17 is a flowchart of an SOS determining process;

FIG. 18 is a flowchart of a server raise-hand responding process;

FIG. 19 is a flowchart of a server SOS responding process; and

FIG. 20 is a diagram showing another example of the teleconference screen.

### DETAILED DESCRIPTION

There are various situations in which teleconferences are conducted. For example, there is a situation in which a small number of users hold a discussion while referring to the same document. In addition, there is a situation in which a large number of users listen to one presenter's speech in a lecture, a debrief session, and so on. In the former situation, each user who operates a terminal apparatus to attend a teleconference speaks frequently. In the latter situation, users who mainly intend to listen have few opportunities to speak. In a teleconference, an authority for the teleconference is given to each of users who attend the teleconference by operating a terminal apparatus. For example, an authority “host” is set to a user who plays a role as a host. Also, an authority “presenter” is set to a user who plays a role as a presenter, and an authority “participant” is set to a user who does not play a role as a host or a presenter. The authority “host” is authority of the highest level. The authority “participant” is authority of the lowest level. The authority “presenter” is authority higher than “participant” and lower than “host”.

Depending on the situation of a teleconference, the stance of a user who attends the teleconference changes. Hence, a configuration that, in response to a speaking request of a particular attendee, the transmission destination of the speaking request changes flexibly depending on the situation of the teleconference will be valuable to all users who attend a teleconference. However, according to the above-described technology, a speaking request is transmitted from the participant terminal to the host terminal regardless of the situation of the teleconference. Hence, the transmission destination of the speaking request cannot be changed flexibly.

An example of the objective of an aspect of this disclosure is to provide a server apparatus and a storage medium storing a program for a server apparatus conducting a teleconference that flexibly determines the transmission destination of various notifications depending on the situation of the teleconference.

<Teleconference System>

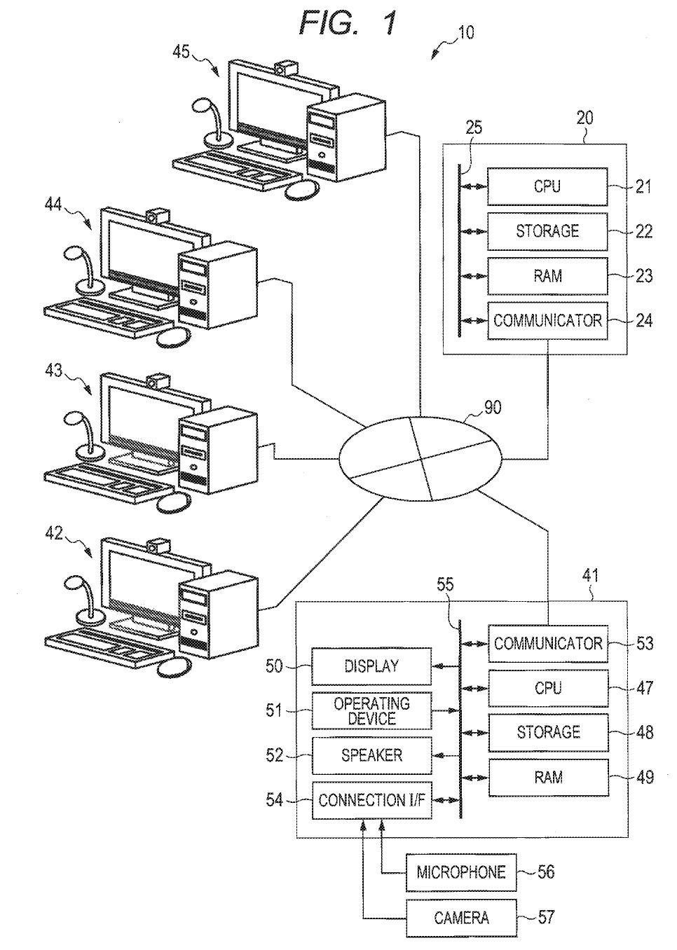

The overview of a teleconference system 10 will be described while referring to FIGS. 1 to 3. As shown in FIG. 1, the teleconference system 10 includes a server apparatus 20 and terminal apparatuses operated by a plurality of users who attend a conference. In FIG. 1, five terminal apparatuses are shown. The number of terminal apparatuses changes depending on the situation of a teleconference that is conducted. In the embodiment, for description purposes, the five terminal apparatuses shown in FIG. 1 are referred to as terminal apparatuses 41, 42, 43, 44, and 45, respectively. That is, it is assumed that the terminal apparatus 41, 42, 43, 44, and 45 are connected to the same teleconference identified by a conference ID.

The conference ID is information that identifies a teleconference conducted by the terminal apparatuses 41, 42, 43, 44, and 45. In the teleconference identified by the conference ID, the terminal apparatuses 41, 42, 43, 44, and 45 are identified by terminal IDs. In the embodiment, each terminal ID of the terminal apparatuses 41, 42, 43, 44, and 45 is as follows. The terminal ID of the terminal apparatus 41 is “USER A”. The terminal ID of the terminal apparatus 42 is “USER B”. The terminal ID of the terminal apparatus 43 is “USER C”. The terminal ID of the terminal apparatus 44 is “USER D”. The terminal ID of the terminal apparatus 45 is “USER E”.

In the teleconference identified by the conference ID, a particular authority is set to each of the terminal apparatuses 41, 42, 43, 44, and 45. The authorities set in teleconference include host, presenter, and participant, for example. Of these three authorities, the host is authority of the highest level, the presenter is authority of the middle level, and the participant is authority of the lowest level. The host is allowed to perform all the functions that are usable in the teleconference system 10. The presenter is restricted from performing part of the functions that are usable in the teleconference system 10. The participant is restricted from performing a larger number of the functions than the presenter is. The functions permitted only to the host include, for example, changes of setting of microphone and camera (audio setting and video setting) in another terminal apparatus, remote control (remote desktop), and addition and deletion of a terminal apparatus that can connect to a teleconference (transmission of a conference request and a forced exit). The functions permitted to the host and presenter include, for example, sharing of a document, addition of a comment, and control of display layout of a terminal apparatus other than the terminal apparatus set as the host or presenter. Each of these functions is used in a known teleconference system. Hence, descriptions of these functions are omitted except the points described below. In the embodiment, authorities set in the teleconference are host, presenter, and participant.

The server apparatus 20 and the terminal apparatuses 41, 42, 43, 44, and 45 are connected to a network 90. For example, the network 90 is a network such as Internet and a local area network (LAN). In the teleconference system 10, a teleconference by the terminal apparatuses 41, 42, 43, 44, and 45 is performed through the server apparatus 20.

The terminal apparatuses 41, 42, 43, 44, and 45 are communication apparatuses having a communication function through the network 90. For example, the terminal apparatuses 41, 42, 43, 44, and 45 are communication apparatuses such as personal computers. Note that the terminal apparatuses 41, 42, 43, 44, and 45 may be communication apparatuses such as a smartphone and a tablet device. The configurations of the terminal apparatuses 41, 42, 43, 44, and 45 will be described later.

The server apparatus 20 performs a teleconference by the terminal apparatuses 41, 42, 43, 44, and 45. In a teleconference in the teleconference system 10, in a similar manner to a known teleconference system, a session is established between each of the terminal apparatuses 41, 42, 43, 44, and 45 and the server apparatus 20. For example, in a state where a session is established, audio data and video data are transmitted and received between the terminal apparatuses 41, 42, 43, 44, and 45 through the server apparatus 20. The audio data and the video data are transmitted in a packet format by a streaming method. The audio data is data of sound collected by a microphone provided at each of the terminal apparatuses 41, 42, 43, 44, and 45.

Regarding generation and transmission of audio data, in the teleconference system 10, collected sound is encoded by a particular cycle (for example, 20 msec). The encoded audio data is transmitted at each timing of this cycle. At this time, the terminal apparatuses 41, 42, 43, 44, and 45 detect the level (volume) of collected sound. When the level of collected sound is higher than or equal to a particular level, the terminal apparatuses 41, 42, 43, 44, and 45 generate audio packet including audio data corresponding to sound higher than or equal to a particular level. The generated audio packet is transmitted to the server apparatus 20. When the level of collected sound is lower than the particular level, audio data is not generated and empty audio packet not including audio data is generated. The generated empty audio packet is transmitted to the server apparatus 20. The empty audio packet includes blank information in a header section. The blank information is information indicating that the audio packet does not include audio data. The video data is image data that is shot by the camera provided at each of the terminal apparatuses 41, 42, 43, 44, and 45. In the embodiment, an image corresponding to video data is referred to as “face image 65”.

In the teleconference system 10, in a similar manner to a known teleconference system, a particular document is shared among the terminal apparatuses 41, 42, 43, 44, and 45. In the embodiment, a document shared among the terminal apparatuses 41, 42, 43, 44, and 45 is referred to as “shared document 64”. The shared document 64 is a document corresponding to shared document data. The shared document data is data of a file format, for example. In the terminal apparatuses 41, 42, 43, 44, and 45, the shared document 64 is displayed in accordance with the shared document data. The shared document data may be image data. For example, in a case where a particular application screen being executed in any one of the terminal apparatuses is shared as the shared document 64, the shared document data is image data generated by capturing the application screen. Each user who operates the terminal apparatuses 41, 42, 43, 44, and 45 attends a teleconference while referring to the shared document 64 displayed on the user's own apparatus.

In the teleconference system 10, a raise-hand function and an SOS function are used. For example, it is assumed that a user who operates the terminal apparatus to which authority “participant” is set has a question about contents spoken by a user who operates the terminal apparatus to which the authority “presenter” is set. In this case, the raise-hand function is used. A user who operates the terminal apparatus to which authority “host” is set can permit or reject speaking of a terminal apparatus of authority “participant”. If speaking is permitted, speaking about the question is possible. That is, audio data corresponding to sound collected by the terminal apparatus to which authority “participant” is set is transmitted to other terminal apparatuses through the server apparatus 20. In the other terminal apparatuses, audio data is played. The user who operates the terminal apparatus to which the authority “presenter” is set speaks about a response to the question. The audio data corresponding to this response is transmitted, through the server apparatus 20, to terminal apparatuses other than the terminal apparatus to which the authority “presenter” is set. In the other terminal apparatuses, this audio data is played.

The SOS function is used between the terminal apparatus to which authority “host” is set and the terminal apparatus to which authority “participant” is set. It is assumed that, in a middle of a teleconference, an unexpected contingency happens to the user who operates the terminal apparatus to which authority “participant” is set. An example of the unexpected contingency is a case where the user does not know an operation method relating to a teleconference. An example of the operation method relating to a teleconference is a method of adjusting the volume of sound. In this case, the SOS function is used, and the solutions are communicated among users who operate the respective terminal apparatuses to which authority “host” is set and to which authority “participant” is set. When the SOS function is used, character data is transmitted and received between the above-described two terminal apparatuses through the server apparatus 20.

In the teleconference system 10, data such as audio data, video data, and character data are transmitted and received among the terminal apparatuses 41, 42, 43, 44, and 45 through the server apparatus 20. In this case, a conference ID and a terminal ID are associated with data to be transmitted.

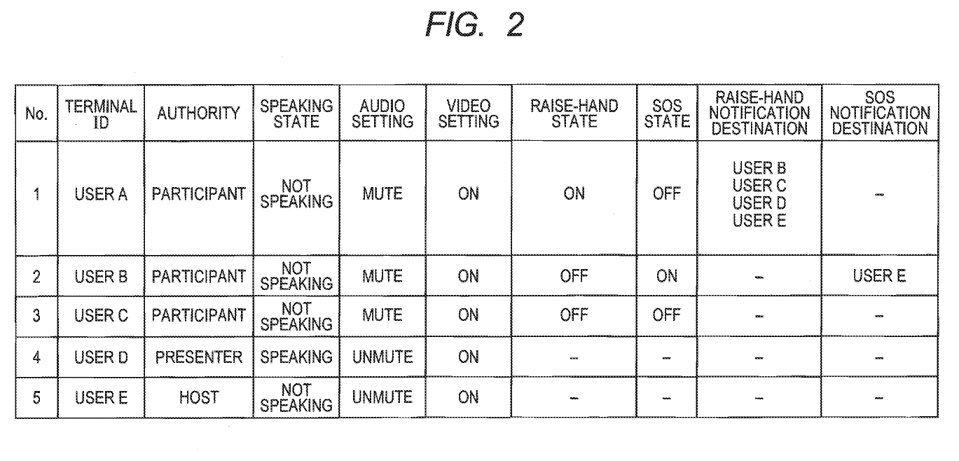

In the server apparatus 20, the database shown in FIG. 2 is managed for each teleconference identified by a conference ID. The database will be described later. The server apparatus 20 receives various data (packet) transmitted from each of the terminal apparatuses 41, 42, 43, 44, and 45, and transmits the data to a particular one of the terminal apparatuses 41, 42, 43, 44, and 45. Here, the various data include the above-described audio data, video data, and character data. For example, it is assumed that the server apparatus 20 has received video data, a conference ID, and a terminal ID

“USER C” from the terminal apparatus 43. In this case, based on the conference ID and the terminal ID “USER C”, the server apparatus 20 identifies, from the database, the terminal apparatuses 41, 42, 44, and 45 having terminal IDs different from this terminal ID. The server apparatus 20 transmits the video data, the conference ID, the terminal ID “USER C” of the terminal apparatus 43 to the identified terminal apparatuses 41, 42, 44, and 45. The terminal apparatuses 41, 42, 44, and 45 having received video data from the terminal apparatus 43 can display the face image 65 that is obtained by decoding the video data.

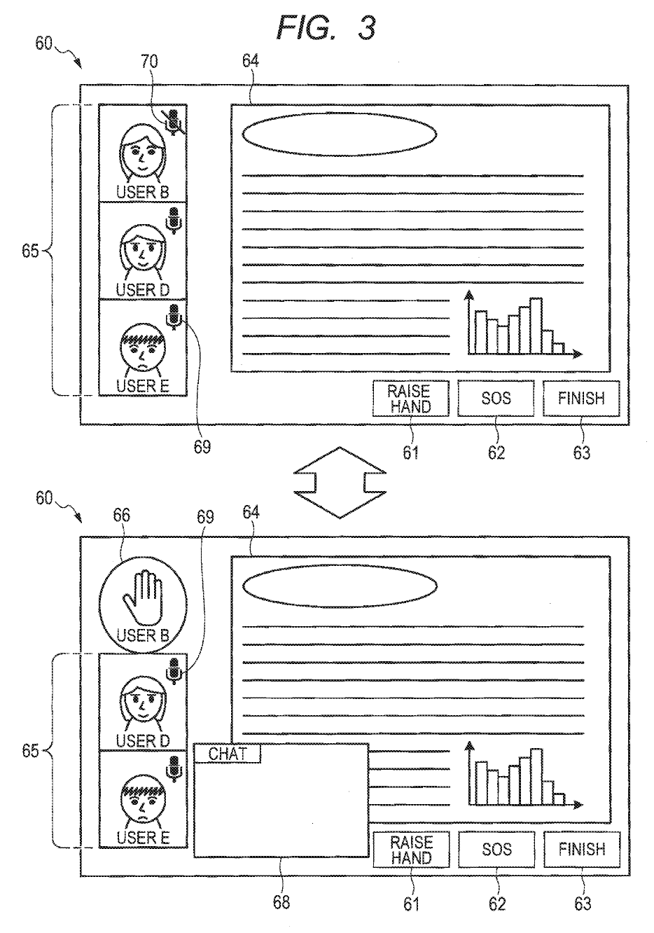

In the teleconference identified by the conference ID, the terminal apparatuses 41, 42, 43, 44, and 45 display a teleconference screen 60. As shown in FIG. 3, the teleconference screen 60 includes a raise-hand button 61, an SOS button 62, and a finish button 63. The shared document 64 and the face image 65 are displayed in the teleconference screen 60. Further, an unmute image 69 and a mute image 70 are displayed in the teleconference screen 60.

The raise-hand button 61 is associated with requesting the raise-hand function. When each user of the terminal apparatuses 41, 42, 43, 44, and 45 wishes to use the raise-hand function, the user presses the raise-hand button 61. The SOS button 62 is associated with a request for the SOS function. When each user of the terminal apparatuses 41, 42, 43, 44, and 45 wishes to use the SOS function, the user presses the SOS button 62. In response to press of the SOS button 62, chat is started between the terminal apparatus at which the SOS button 62 is pressed and the terminal apparatus to which authority “host” is set. The raise-hand button 61 and the SOS button 62 may be omitted in the teleconference screen displayed at the terminal apparatus to which authority “host” or “presenter” is set. This point will be described later. The finish button 63 is associated with finishing of the teleconference. When each user of the terminal apparatuses 41, 42, 43, 44, and 45 wishes to finish the teleconference, the user presses the finish button 63. In this case, the teleconference is finished, and the session established with the server apparatus 20 is terminated.

In the terminal apparatuses 41, 42, 43, 44, and 45, display or non-display of the shared document 64 and display or non-display of the face image 65 in the teleconference screen 60 can be set. The display or non-display of the face image 65 can be set individually for each face image 65. In the teleconference screen 60, the face image 65 corresponding to video data shot by the user's own apparatus can also be displayed. Note that, in the embodiment, the face image 65 of the user's own apparatus is set to non-display. In the teleconference screen 60 shown in FIG. 3, the face images 65 of the terminal apparatuses 41, 43 having terminal IDs “USER A” and “USER C” are set to non-display. In the embodiment, the face image 65 corresponds to each face image of the terminal apparatuses 41, 42, 43, 44, and 45, or represents these collectively.

When the raise-hand function is used, the raise-hand image 66 is displayed. For example, it is assumed that an operation of requesting the raise-hand function is performed at the terminal apparatus 42, in a state where the face image 65 of the terminal apparatus 42 of the terminal ID “USER B” is set to display (see the upper part of FIG. 3). In this case, in the teleconference screen 60, the face image 65 of the terminal apparatus 42 is switched to the raise-hand image 66 (see the lower part of FIG. 3). Note that the raise-hand image 66 may be displayed in a manner overlapping the face image 65 of the terminal apparatus 42, for example. In the embodiment, images of the face image 65 and the raise-hand image 66 are switchingly displayed.

It is assumed that an operation of requesting the raise-hand function is performed at one of the terminal apparatuses 41 and 43, in a state where the face image 65 is set to non-display. In this case, in the teleconference screen 60, the raise-hand image 66 is displayed by pop-up. In this case, the raise-hand image 66 may be displayed in a state where the raise-hand image 66 is associated with the terminal ID of the terminal apparatus having requested for the raise-hand function. For example, it is assumed that an operation of requesting the raise-hand function is performed at the terminal apparatus 41 having the terminal ID “USER A” for which the face image 65 is set to non-display. In this case, in the teleconference screen 60, the raise-hand image 66 is displayed by pop-up in a state where the raise-hand image 66 is associated with the terminal ID “USER A”.

The unmute image 69 is an image corresponding to audio setting “Unmute” described later. The unmute image 69 is displayed so as to correspond to the face image 65 of the terminal apparatus having the terminal ID of audio setting “Unmute”.

The mute image 70 is an image corresponding to audio setting “Mute” described later. The mute image 70 is displayed so as to correspond to the face image 65 of the terminal apparatus having the terminal ID of audio setting “Mute”.

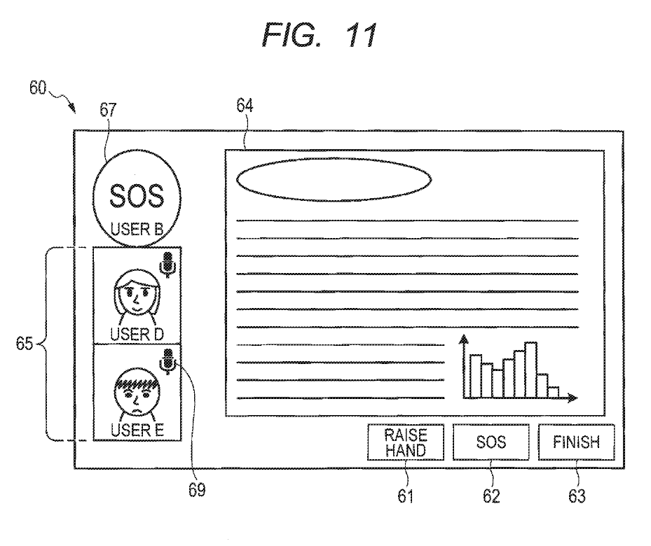

When the SOS function is used, an SOS image 67 (see FIG. 11) is displayed. The SOS image 67 is displayed in the teleconference screen 60 in response to press of the SOS button 62 at a particular terminal apparatus. At particular timing after the SOS image 67 is displayed, a chat screen 68 is displayed at a particular position in the teleconference screen 60. This point will be described later. In the lower part of FIG. 3, the chat screen 68 is displayed in a manner overlapping the shared document 64. The chat screen 68 displays characters received at the user's own apparatus and characters corresponding to character data from the terminal apparatus of the chat counterpart. The chat process for realizing the SOS function is executed at the same procedure as a known chat process. Accordingly, descriptions of the chat process will be omitted.

<Server Apparatus>

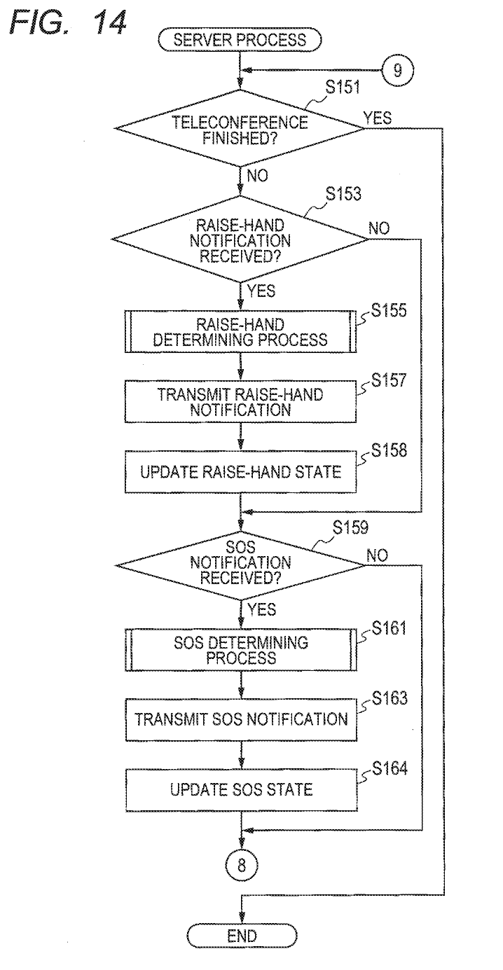

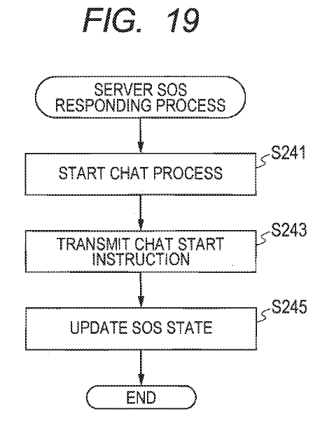

As shown in FIG. 1, the server apparatus 20 includes a CPU 21, a storage 22, a RAM 23, and a communicator 24. These devices 21 to 24 are connected to a bus 25. The CPU 21 executes arithmetic processes. The storage 22 includes a computer-readable storage medium. For example, the storage 22 includes a hard disk and/or a flash memory. Also, the storage 22 may include a ROM. The storage 22 stores various programs. For example, the storage 22 stores an OS (Operating System) and various applications. The applications stored in the storage 22 include programs of each process executed by the server apparatus 20 described later (see FIGS. 14 to 19) and a program of a chat process (see S241 of FIG. 19). The programs of each process described later are preliminarily installed in the storage 22.

For example, the preliminary install is performed by reading a program stored in a computer-readable storage medium such as a semiconductor memory by a reader (not shown) of the server apparatus 20. If the server apparatus 20 includes an optical drive (not shown), for example, the preliminary install may be performed by reading the program stored in an optical medium by the optical drive. Also, the preliminary install may be performed by receiving the program stored in a computer-readable storage medium such as a hard disk of a server apparatus different from the server apparatus 20 connected to the network 90, as transmission signals, by the communicator 24 of the server apparatus 20. Which method is adopted is determined appropriately by considering various conditions. The computer-readable storage medium may be a non-transitory storage medium that does not include a transitory storage medium (for example, transmission signals). It is sufficient that a non-transitory storage medium store information, irrespective of a time period of storing the information.

The RAM 23 is a memory area that is used when the CPU 21 executes various programs. The RAM 23 stores, in a particular storage area, particular data and information that are used by a process when the process is executed. For example, the RAM 23 stores a database shown in FIG. 2. Alternatively, the database may be stored in the storage 22. The database stores terminal IDs, authorities, speaking states, audio settings, video settings, raise-hand states, SOS states, raise-hand notification destinations, and SOS notification destinations in association with one another. The terminal IDs are as described above. Accordingly, descriptions about the terminal IDs are omitted.

The authorities are set to respective ones of the terminal apparatuses 41, 42, 43, 44, and 45. In the example shown in FIG. 2, the authority “participant” is set to terminal ID “USER A” (the terminal apparatus 41), “USER B” (the terminal apparatus 42), and “USER C” (the terminal apparatus 43). The authority “presenter” is set to terminal ID “USER D” (the terminal apparatus 44). The authority “host” is set to terminal ID “USER E” (the terminal apparatus 45). In the example shown in FIG. 2, each of the authorities “host” and “presenter” is set to one terminal ID. However, in one teleconference identified by one conference ID, the authority “host” can be set to a plurality of terminal IDs. The same goes for the authority “presenter”.

The speaking state is information indicative of whether each user operating the terminal apparatuses 41, 42, 43, 44, and 45 is currently speaking. It is assumed that an audio packet including audio data is received by the communicator 24 successively a particular number of times. In this case, the CPU 21 of the server apparatus 20 stores “speaking” as the speaking state associated with the terminal ID included in the audio packet together with the audio data. It is assumed that an empty audio packet including blank information in a header portion is received by the communicator 24 successively a particular number of times. In this case, the CPU 21 stores “not speaking” as the speaking state associated with the terminal ID included in the audio packet together with the blank information.

The audio setting is setting relating to permission and non-permission for transmitting audio data, and is set to either “Unmute” or “Mute”. When the audio setting is “Unmute”, the terminal apparatus of the terminal ID associated with this audio setting transmits audio data (audio packet) to the server apparatus 20. That is, the audio data is transmitted from the above-described terminal apparatus to the server apparatus 20.

Accordingly, the user operating this terminal apparatus can speak in the teleconference. When the audio setting is “Mute”, the terminal apparatus of the terminal ID associated with this audio setting is restricted from transmitting audio data to the server apparatus 20. That is, audio data is not transmitted from the above-described terminal apparatus to the server apparatus 20. Accordingly, the user operating this terminal apparatus cannot speak in the teleconference. When the audio setting is “Mute”, the CPU 21 may store “not speaking” as the speaking state.

The teleconference system 10 may execute the following process, depending on the audio setting “Unmute” or “Mute”. That is, the terminal apparatus transmits audio data to the server apparatus 20, regardless of the audio setting “Unmute” or “Mute”. The server apparatus 20 transmits, to other terminal apparatuses, audio data transmitted from the terminal apparatus having the audio setting “Unmute”. The server apparatus 20 does not transmit, to other terminal apparatuses, audio data transmitted from the terminal apparatus having the audio setting “Mute”. With this configuration, the above-described effect can also be realized.

The video setting is setting relating to permission and non-permission for transmitting video data, and is set to either “ON” or “OFF”. When the video setting is “ON”, video data is transmitted to the server apparatus 20. That is, video data is transmitted from the above-described terminal apparatus to the server apparatus 20. When the video setting is “OFF”, the terminal apparatus of the terminal ID associated with this video setting is restricted from transmitting video data to the server apparatus 20. That is, video data is not transmitted from the above-described terminal apparatus to the server apparatus 20. In FIG. 2, the video setting is set to “ON” for all the terminal IDs.

For example, in a small-scale teleconference having a small total number of terminal apparatuses (a total number of terminal IDs) (in the embodiment, the total number of the terminal apparatuses is five), by setting the video setting to “ON” for all the terminal IDs, the face images 65 of all the terminal apparatuses 41, 42, 43, 44, and 45 can be displayed in the teleconference screen 60. On the other hand, in a large-scale teleconference such as a lecture and a debrief session, for example, the video setting is set to “ON” for the terminal ID having the authorities “host” and “presenter”, and the video setting is set to “OFF” for the terminal ID having the authority “participant”. This suppresses that video data of terminal apparatuses operated by mere attendees is transmitted to other terminal apparatuses through the server apparatus 20.

The teleconference system 10 may execute the following process, depending on the video setting “ON” or “OFF”. That is, the terminal apparatus transmits video data to the server apparatus 20, regardless of the video setting “ON” or “OFF”. The server apparatus 20 transmits, to other terminal apparatuses, video data transmitted from the terminal apparatus having the video setting “ON”. The server apparatus 20 does not transmit, to other terminal apparatuses, video data transmitted from the terminal apparatus having the video setting “OFF”. With this configuration, the above-described effect can also be realized.

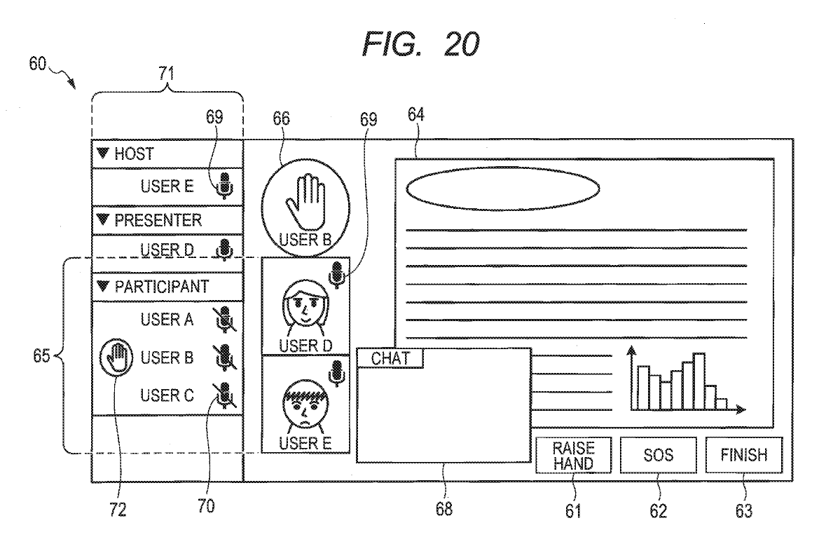

The raise-hand state, the SOS state, the raise-hand notification destination, and the SOS notification destination will be described later. The storage state of the database shown in FIG. 2 is just an example. In the embodiment, correspondence is not taken into account between the storage state of the database shown in FIG. 2, and the display mode of the teleconference screen 60 shown in the lower part of FIG. 3 or the display mode of the teleconference screen 60 shown in FIG. 11 described later. The same goes for correspondence with FIG. 20 described later. In the embodiment, some descriptions are based on a state different from the storage state of the database shown in FIG. 2.

In the server apparatus 20, the CPU 21 controls the server apparatus 20 by executing the OS stored in the storage 22 and programs of each process shown in FIGS. 14 to 19 and so on. With this operation, the server apparatus 20 executes various processes to realize various functions.

The communicator 24 connects the server apparatus 20 to the network 90, and performs data communication with the network 90. The server apparatus 20 performs transmission and reception of various data with the terminal apparatuses 41, 42, 43, 44, and 45 through the communicator 24. The communicator 24 is an interface circuit that is adapted to the ETHERNET™ standard, for example. Connection to the network 90 by the communicator 24 is wired connection. However, connection to the network 90 by the communicator 24 may be wireless connection.

The server apparatus 20 is different from a known server apparatus in that the storage 22 stores the programs of each process described later (FIGS. 14 to 19). However, in terms of hardware, the server apparatus 20 may be an information processing apparatus having the same communication functions as a known server apparatus. Accordingly, the server apparatus 20 further includes configurations provided in a known server apparatus.

<Terminal Apparatus>

As shown in FIG. 1, the terminal apparatus 41 includes a CPU 47, a storage 48, a RAM 49, a display 50, an operating device 51, a speaker 52, a communicator 53, and a connection interface 54. These devices 47 to 54 are connected to a bus 55. In the embodiment, the connection interface 54 is abbreviated as “connection I/F 54”. A microphone 56 and a camera 57 are connected to the connection I/F 54. The terminal apparatuses 42, 43, 44, and 45 are the same or the same type communication apparatuses as the terminal apparatus 41. Accordingly, the terminal apparatuses 42, 43, 44, and 45 have the same configuration as the terminal apparatus 41. The terminal apparatus 41 will be described as an example of the terminal apparatuses 41, 42, 43, 44, and 45, and descriptions of the terminal apparatuses 42, 43, 44, and 45 are omitted.

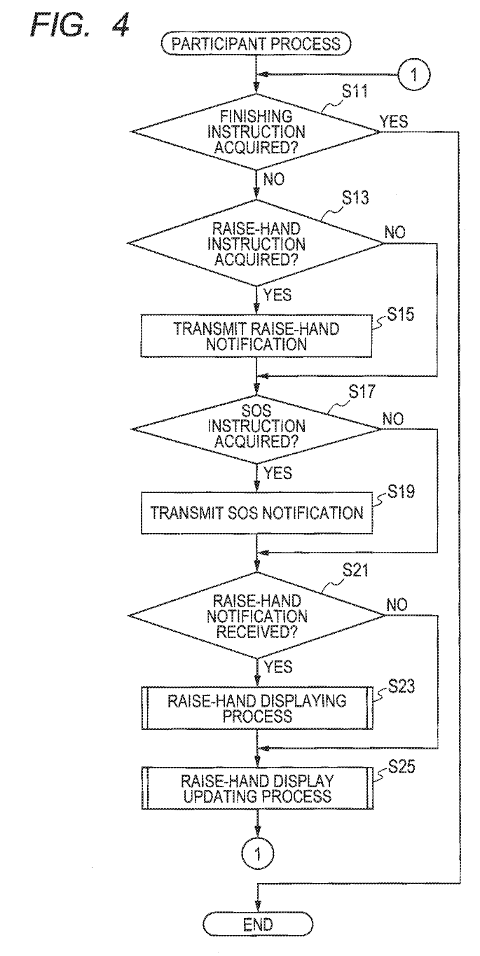

The CPU 47 executes arithmetic processes. The storage 48 includes a computer-readable storage medium. For example, the storage 48 includes a hard disk and/or flash memory. Also, the storage 48 may include a ROM. The storage 48 stores various programs. For example, the storage 48 stores an OS and various applications. The applications stored in the storage 48 include programs of each process executed by the terminal apparatus 41 described later (see FIGS. 4 to 10, 12, and 13) and a program for chat. Note that the applications stored in the storage 48 are programs provided depending on the authority set to the terminal apparatus 41.

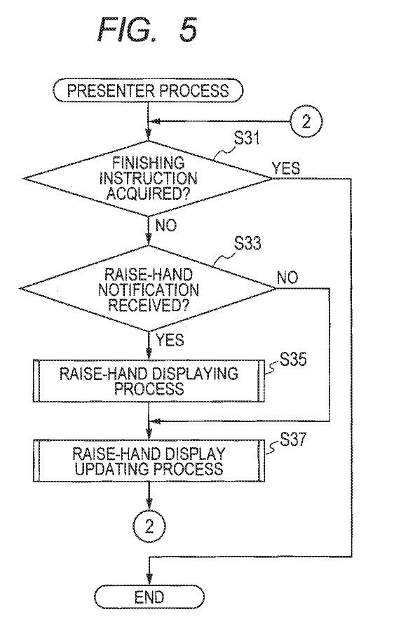

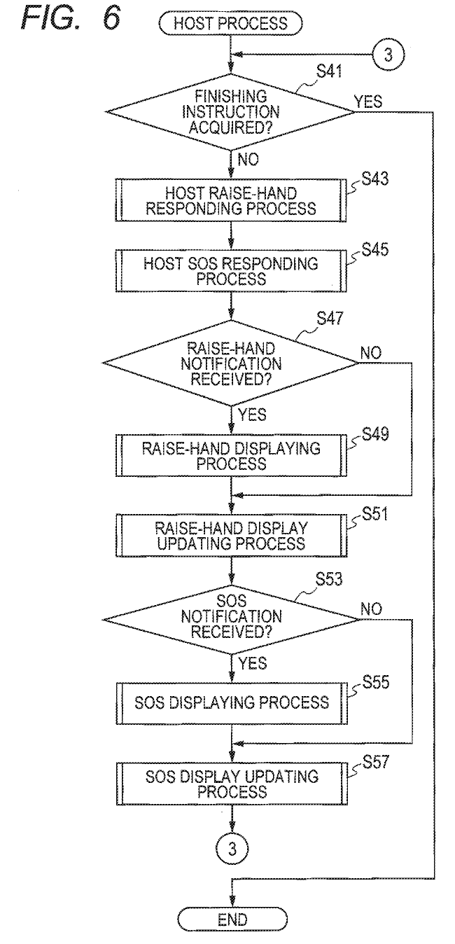

For example, it is assumed that the authority set to the terminal apparatus 41 is participant. In this case, the storage 48 stores programs of each process in FIGS. 4, 7, and 8 and the program for chat. It is assumed that the authority set to the terminal apparatus 41 is presenter. In this case, the storage 48 stores programs of each process in FIGS. 5, 7, and 8. It is assumed that the authority set to the terminal apparatus 41 is host. In this case, the storage 48 stores programs of each process in FIGS. 6 to 10, 12, and 13 and the program for chat. These programs of each process may be a single program including all of each program module for each authority of participant, presenter, and host and a program module for chat. The storage 48 stores the above-described single program regardless of the authority set to the terminal apparatus 41. The terminal apparatus 41 appropriately executes a program module depending on the authority.

These programs of each process may be preliminarily installed in the storage 48. Alternatively, these programs may be transmitted to the terminal apparatus 41 as transmission signals through the network 90 from the server apparatus 20 when the terminal apparatus 41 accesses the server apparatus 20 for connecting to a teleconference, and may be installed in the storage 48 at that timing. In this case, the program may be stored in the RAM 49. For example, the preliminary install is performed by reading a program stored in a computer-readable storage medium such as a semiconductor memory by a reader (not shown) of the terminal apparatus 41. If the terminal apparatus 41 includes an optical drive (not shown), for example, the preliminary install may be performed by reading the program stored in an optical medium by the optical drive. Also, the preliminary install may be performed by receiving the program stored in a computer-readable storage medium such as a hard disk of a server apparatus (the server apparatus 20 or a server apparatus not shown in the drawings) connected to the terminal apparatus 41 through the network 90, as transmission signals, by the communicator 53 of the terminal apparatus 41. Which method is adopted is determined appropriately by considering various conditions. The computer-readable storage medium may be a non-transitory storage medium that does not include a transitory storage medium (for example, transmission signals). It is sufficient that a non-transitory storage medium store information, irrespective of a time period of storing the information.

The RAM 49 is a memory area that is used when the CPU 47 executes various programs. The RAM 49 stores particular data and information that are used by a process when the process is executed. In the terminal apparatus 41, the CPU 47 appropriately executes the OS stored in the storage 48 and the programs of each process shown in FIGS. 4 to 10, 12, and 13, thereby controlling the terminal apparatus 41.

With this operation, the terminal apparatus 41 executes various processes to realize various functions.

The display 50 is a liquid crystal display, for example. The display 50 displays various kinds of information. The display 50 displays the teleconference screen 60. The operating device 51 receives inputs such as various instructions to the terminal apparatus 41. The operating device 51 includes a keyboard and a mouse. Details are omitted, but a process that generates operational information corresponding to each operation to the keyboard and mouse is technology used in known personal computers. The terminal apparatus 41 also adopts this technology.

The speaker 52 is an example of a sound output device that outputs sound. For example, sound outputted by the speaker 52 is sound corresponding to audio data transmitted from the server apparatus 20 described above. The communicator 53 connects the terminal apparatus 41 to the network 90, and performs data communication through the network 90. In the terminal apparatus 41, various data are transmitted to and received from the server apparatus 20 through the communicator 53. The communicator 53 is an interface circuit that is adapted to the ETHERNET™ standard, for example. Connection to the network 90 by the communicator 53 may be wireless connection or wired connection.

The connection I/F 54 is an interface for connecting a particular device to the terminal apparatus 41. For example, the connection I/F 54 is an interface having a USB (Universal Serial Bus) port. The microphone 56 connected to the connection I/F 54 is an example of a sound collector that collects external sound. For example, the microphone 56 collects voices outputted by a user who operates the terminal apparatus 41. The camera 57 connected to the connection I/F 54 captures an external image. The terminal apparatus 41 may have a built-in camera.

The terminal apparatus 41 is different from a known communication apparatus in that the storage 48 or the RAM 49 stores programs of each process described later (see FIGS. 4 to 10, 12, and 13). However, in terms of hardware, the terminal apparatus 41 may be a communication apparatus that is the same as a known communication apparatus.

<Process Executed by Terminal Apparatus>

Each process executed by the terminal apparatuses 41, 42, 43, 44, and 45, when a teleconference are conducted by the terminal apparatuses 41, 42, 43, 44, and 45, will be described. A participant process shown in FIG. 4, a presenter process shown in FIG. 5, and a host process shown in FIG. 6 are executed in a state where a session with the server apparatus 20 is established and data communication for the teleconference is started with the server apparatus 20. When a session is established with the server apparatus 20, the terminal apparatuses 41, 42, 43, 44, and 45 execute similar processes to processes executed in a known teleconference system. Thus, descriptions of the processes executed by the terminal apparatuses 41, 42, 43, 44, and 45 when establishing a session with the server apparatus 20 will be omitted. When the session is established or after the session is established, the terminal apparatuses 41, 42, 43, 44, and 45 display the teleconference screen 60. In the teleconference screen 60 in the teleconference identified by the same conference ID, the face images 65 of other terminal apparatuses for which a session is established with the server apparatus 20 are displayed.

The participant process shown in FIG. 4 is executed by the terminal apparatus to which the authority “participant” is set, out of the terminal apparatuses 41, 42, 43, 44, and 45. The presenter process shown in FIG. 5 is executed by the terminal apparatus to which the authority “presenter” is set, out of the terminal apparatuses 41, 42, 43, 44, and 45. The host process shown in FIG. 6 is executed by the terminal apparatus to which the authority “host” is set, out of the terminal apparatuses 41, 42, 43, 44, and 45. The terminal apparatuses 41, 42, 43, 44, and 45 acquire information indicative of the authority set to the apparatus itself in the process of establishing the session. The terminal apparatuses 41, 42, 43, 44, and 45 start up the program of the process corresponding to the acquired information indicative of the authority, out of the participant process, the presenter process, and the host process, and starts the started-up process.

Hereinafter, a case in which each process shown in FIGS. 4 to 10, 12, and 13 is executed by the terminal apparatus 41, regardless of the storage state of the database shown in FIG. 2 (the authority “participant” is set to the terminal ID “USER A”) will be described. The terminal apparatuses 42, 43, 44, and 45 also execute the process that is described by taking the terminal apparatus 41 as an example, in a similar manner to the terminal apparatus 41.

<Participant Process>

The participant process will be described while referring to FIG. 4. The CPU 47 having started the participant process determines whether a finishing instruction has been acquired (S11). The user operates the operating device 51 to press the finish button 63. When a press of the finish button 63 has been received by the operating device 51, the CPU 47 acquires a finishing instruction. When the finishing instruction has been acquired (S11: Yes), the CPU 47 ends the participant process. In this case, the CPU 47 executes a procedure of cutting off the session with the server apparatus 20, by communicating with the server apparatus 20. This finishes the teleconference at the terminal apparatus 41.

When no finishing instruction is acquired (S11: No), the CPU 47 determines whether a raise-hand instruction has been acquired (S13). The user operates the operating device 51 to press the raise-hand button 61. When a press of the raise-hand button 61 has been received by the operating device 51, the CPU 47 acquires a raise-hand instruction. When the raise-hand instruction has been acquired (S13: Yes), the CPU 47 controls transmission of a raise-hand notification (S15). The raise-hand notification is a notification of requesting usage of the raise-hand function. The raise-hand notification includes the conference ID and the terminal ID of the user's own apparatus. The transmission destination is set to the server apparatus 20. The CPU 47 outputs a transmission command of the raise-hand notification to the communicator 53. With this operation, the raise-hand notification is transmitted from the communicator 53 to the server apparatus 20.

When no raise-hand instruction is acquired (S13: No) or after S15 is executed, the CPU 47 determines whether an SOS instruction has been acquired (S17). The user operates the operating device 51 to press the SOS button 62. When a press of the SOS button 62 has been received by the operating device 51, the CPU 47 acquires an SOS instruction. When the SOS instruction has been acquired (S17: Yes), the CPU 47 controls transmission of an SOS notification (S19). The SOS notification is a notification of requesting usage of the SOS function. The SOS notification includes the conference ID and the terminal ID of the user's own apparatus. The transmission destination is set to the server apparatus 20. The CPU 47 outputs a transmission command of the SOS notification to the communicator 53. With this operation, the SOS notification is transmitted from the communicator 53 to the server apparatus 20.

Next, when no SOS instruction is acquired (S17: No) or after S19 is executed, the CPU 47 determines whether a raise-hand notification has been acquired (S21). The raise-hand notification is transmitted from the server apparatus 20 in S157 of FIG. 14, and is received by the communicator 53. The CPU 47 acquires the raise-hand notification through the communicator 53. When the raise-hand notification has been acquired (S21: Yes), the CPU 47 executes a raise-hand displaying process (S23). The raise-hand displaying process will be described later. The acquired raise-hand notification is stored in the RAM 49.

When no raise-hand notification is acquired (S21: No) or after S23 is executed, the CPU 47 executes a raise-hand display updating process (S25). The raise-hand display updating process will be described later. After executing S25, the CPU 47 returns the process to S11. After that, the CPU 47 repeatedly executes the processes in S11 and thereafter.

<Presenter Process>

The presenter process will be described while referring to FIG. 5. The CPU 47 having started the presenter process appropriately executes each process of S31 to S37. Here, S31 is a process corresponding to S11 of FIG. 4. S33 is a process corresponding to S21 of FIG. 4. When determination is positive in S33 (S33: Yes), the acquired raise-hand notification is stored in the RAM 49 in a similar manner to the above. When determination is negative in S33 (S33: No), the CPU 47 moves the process to S37. S35 is a process corresponding to S23 of FIG. 4. S37 is a process corresponding to S25 of FIG. 4. The CPU 47 executes S31 to S37 in a similar manner to the above.

After executing S37, the CPU 47 returns the process to S31. After that, the CPU 47 repeatedly executes the processes in S31 and thereafter. When the finishing instruction has been acquired (S31: Yes), the CPU 47 ends the presenter process. In this case, the CPU 47 cuts off the session with the server apparatus 20 in a similar manner to the above. This finishes the teleconference at the terminal apparatus 41.

The presenter process does not include processes corresponding to S13 to S19 of FIG. 4. This is because the raise-hand instruction and the SOS instruction are not acquired in the presenter process. Accordingly, the raise-hand button 61 and the SOS button 62 may be omitted in the teleconference screen displayed at the terminal apparatus to which the authority “presenter” is set. In FIG. 2, the terminal apparatus to which the authority “presenter” is set is the terminal apparatus 44 having the terminal ID “USER D”.

<Host Process>

The host process will be described while referring to FIG. 6. The CPU 47 having started the host process determines whether a finishing instruction has been acquired (S41). The CPU 47 acquires the finishing instruction in a similar manner to the above (see S11 of FIG. 4). Hence, description relating to acquisition of the finishing instruction will be omitted. When the finishing instruction has been acquired (S41: Yes), the CPU 47 ends the host process. In this case, in a similar manner to the above, the CPU 47 cuts off the session with the server apparatus 20. This finishes the teleconference at the terminal apparatus 41.

When no finishing instruction is acquired (S41: No), the CPU 47 executes a host raise-hand responding process (S43). The host raise-hand responding process will be described later. After executing S43, the CPU 47 executes a host SOS responding process (S45). The host SOS responding process will be described later. After executing S45, the CPU 47 appropriately executes each process of S47 to S51. Here, S47 is a process corresponding to S21 of FIG. 4. When determination is positive in S47 (S47: Yes), the acquired raise-hand notification is stored in the RAM 49 in a similar manner to the above. When determination is negative in S47 (S47: No), the CPU 47 moves the process to S51. S49 is a process corresponding to S23 of FIG. 4. S51 is a process corresponding to S25 of FIG. 4. The CPU 47 executes S47 to S51 in a similar manner to the above.

After executing S51, the CPU 47 determines whether an SOS notification has been acquired (S53). The SOS notification is transmitted from the server apparatus 20 in S163 of FIG. 14 and is received by the communicator 53. The CPU 47 acquires the SOS notification through the communicator 53. When the SOS notification has been acquired (S53: Yes), the CPU 47 executes an SOS displaying process (S55). The SOS displaying process will be described later. The acquired SOS notification is stored in the RAM 49.

When no SOS notification is acquired (S53: No) or after S55 is executed, the CPU 47 executes an SOS display updating process (S57). The SOS display updating process will be described later. After executing S57, the CPU 47 returns the process to S41. After that, the CPU 47 repeatedly executes the processes of S41 and thereafter.

The host process does not include processes corresponding to S13 to S19 of FIG. 4. This is because the raise-hand instruction and the SOS instruction are not acquired in the host process. Accordingly, the raise-hand button 61 and the SOS button 62 may be omitted in the teleconference screen displayed at the terminal apparatus to which the authority “host” is set. In FIG. 2, the terminal apparatus to which the authority “host” is set is the terminal apparatus 45 having the terminal ID “USER E”.

<Raise-Hand Displaying Process>

The raise-hand displaying process executed in S23 of FIG. 4, S35 of

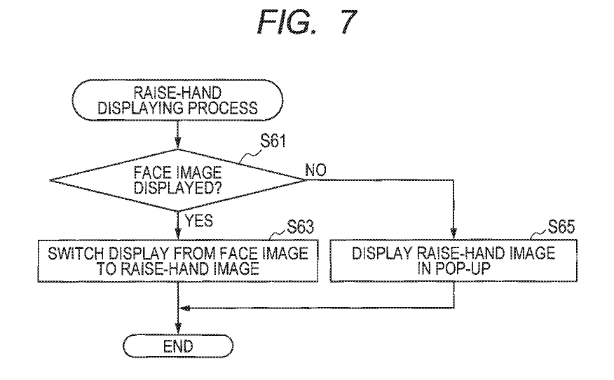

FIG. 5, or S49 of FIG. 6 will be described while referring to FIG. 7. The CPU 47 having started the raise-hand displaying process determines whether the face image 65 described below is displayed in the teleconference screen 60 (S61). The face image 65 to be determined is the face image corresponding to video data including the terminal ID described below. The above-described terminal ID is the terminal ID included in the raise-hand notification acquired before starting the raise-hand displaying process (see S21 of FIG. 4, S33 of FIG. 5, S47:Yes of FIG. 6). As described above, the raise-hand notification is stored in the RAM 49 (see S21 of FIG. 4, S33 of FIG. 5, S47:Yes of FIG. 6). In S61, the CPU 47 determines whether the display setting of the above-mentioned face image 65 is either display or non-display. The CPU 47 makes a positive determination in S61 when the setting of the face image 65 to be determined is “display” (S61: Yes), and makes a negative determination in S61 when the setting of the face image 65 to be determined is “non-display” (S61: No).

When determination is positive in S61 (S61: Yes), the CPU 47 controls to switch display from the face image 65 determined in S61 to the raise-hand image 66 (S63). That is, the CPU 47 outputs, to the display 50, a display command of displaying the raise-hand image 66 at the position where the above-mentioned face image 65 is displayed. With this operation, in the display 50, display of the teleconference screen 60 is switched from the state shown in the upper part of FIG. 3 to the state shown in the lower part.

When determination is negative in S61 (S61: No), the CPU 47 controls to display the raise-hand image 66 in pop-up (S65). That is, the CPU 47 outputs, to the display 50, a display command of displaying the raise-hand image 66 at a particular position. With this operation, in the display 50, the raise-hand image 66 is popped up at the particular position. The particular position at which the raise-hand image 66 is popped up is set appropriately at a position that does not overlap the displayed face image 65. In FIG. 3, the raise-hand image 66 that is popped up in this way is omitted from the drawing. In S63 or S65, information corresponding to the terminal ID included in the raise-hand notification may be displayed together with the display of the raise-hand image 66. For example, it is assumed that the raise-hand notification includes the terminal ID “USER B”. In this case, the raise-hand image 66 including texts “USER B” may be displayed. After executing S63 or S65, the CPU 47 ends the raise-hand displaying process.

<Raise-Hand Display Updating Process>

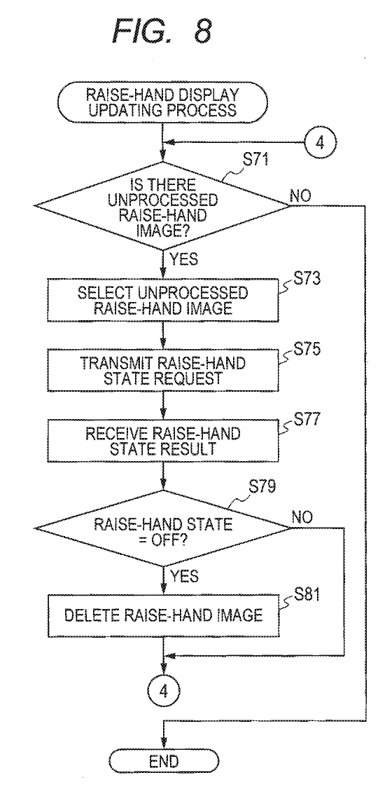

The raise-hand display updating process executed in S25 of FIG. 4, S37 of FIG. 5, or S51 of FIG. 6 will be described while referring to FIG. 8. The CPU 47 having started the raise-hand display updating process determines whether there is unprocessed raise-hand image 66 in the raise-hand images 66 displayed in the teleconference screen 60 (S71). The unprocessed raise-hand image 66 is a raise-hand image that has not become the process target in S75 to S81. When there is no unprocessed raise-hand image 66 (S71: No), the CPU 47 ends the raise-hand display updating process. When no raise-hand image 66 is displayed, there is no unprocessed raise-hand image 66 and hence determination is negative in S71 (S71: No).

When there is one or more unprocessed raise-hand image 66 (S71: Yes), the CPU 47 selects one unprocessed raise-hand image 66 as a process target (S73). Next, the CPU 47 controls transmission of a raise-hand state request (S75). The raise-hand state request is an instruction of requesting transmission of the raise-hand state that is managed by the server apparatus 20. The raise-hand state request includes the terminal ID corresponding to the raise-hand image 66 of the process target and the terminal ID of the user's own apparatus. The terminal ID corresponding to the raise-hand image 66 is included in the raise-hand notification for which the raise-hand image 66 of the process target is displayed in S63 or S65 of the raise-hand displaying process (see FIG. 7) executed in S23 of FIG. 4, S35 of FIG. 5, or S49 of FIG. 6. The transmission destination is set to the server apparatus 20. The CPU 47 outputs, to the communicator 53, a transmission command of the raise-hand state request including the above-described terminal ID. With this operation, the raise-hand state request is transmitted from the communicator 53 to the server apparatus 20.

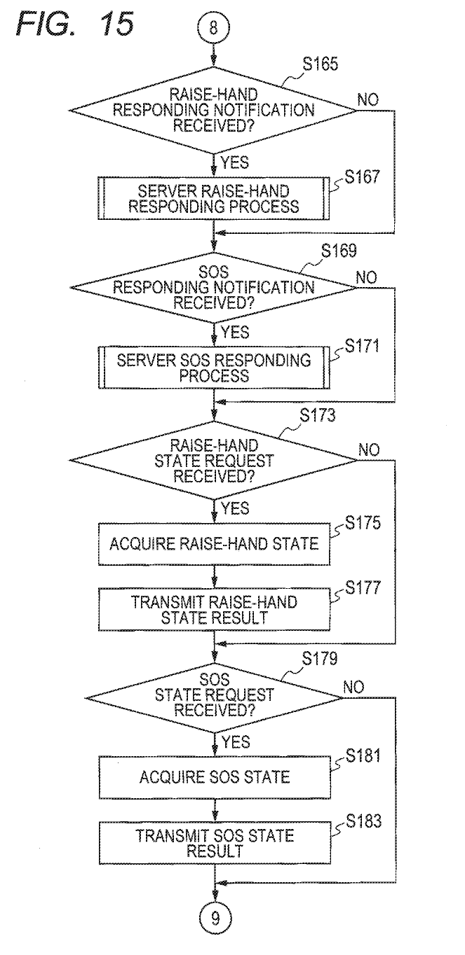

Next, the CPU 47 acquires a raise-hand state result (S77). The raise-hand state result includes the raise-hand state corresponding to the terminal ID included in the raise-hand state request. The above-mentioned terminal ID corresponds to the raise-hand image 66 of the process target out of the above-mentioned two terminal IDs. The raise-hand state result is transmitted from the server apparatus 20 in S177 of FIG. 15, and is received by the communicator 53. The CPU 47 acquires the raise-hand state result through the communicator 53. Next, the CPU 47 determines whether the raise-hand state included in the acquired raise-hand state result is “OFF” (S79). When the raise-hand state is “OFF” (S79: Yes), the CPU 47 controls deletion of the raise-hand image 66 of the process target (S81). That is, the CPU 47 outputs, to the display 50, a deletion command of the raise-hand image 66 of the process target. With this operation, in the display 50, the raise-hand image 66 of the process target is hidden (non-display). It can be said that, based on deletion of the raise-hand image 66 in S81, the raise-hand state result including the raise-hand state “OFF” is a notification indicative of cancellation of the raise-hand function based on the raise-hand notification.

When the raise-hand state is not “OFF” but “ON” (S79: No) or after S81 is executed, the CPU 47 returns the process to S71. After that, the CPU 47 repeatedly executes the process of S71 and thereafter.

<Host Raise-Hand Responding Process>

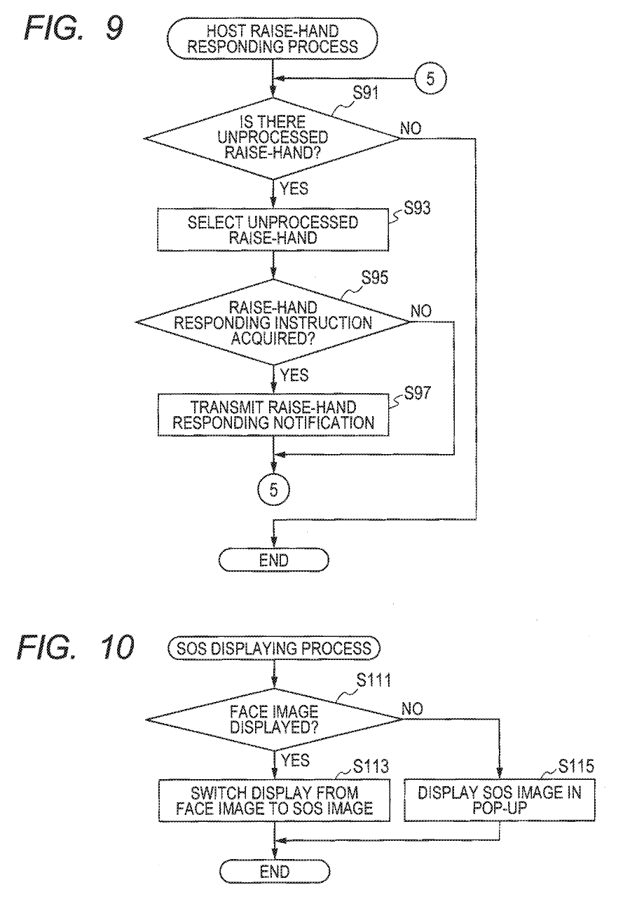

The host raise-hand responding process executed in S43 of FIG. 6 will be described while referring to FIG. 9. The CPU 47 having started the host raise-hand responding process determines whether there is unprocessed raise-hand in the raise-hand corresponding to the raise-hand image 66 displayed in the teleconference screen 60 (S91). The unprocessed raise-hand is raise-hand that has not become the process target in S95 and S97. When there is no unprocessed raise-hand (S91: No), the CPU 47 ends the host raise-hand responding process. When the raise-hand image 66 is not displayed, there is no unprocessed raise-hand and hence determination is negative in S91 (S91: No).

When there is one or more unprocessed raise-hand (S91: Yes), the CPU 47 selects one unprocessed raise-hand as a process target (S93). Next, the CPU 47 determines whether a raise-hand responding instruction for the raise-hand of the process target has been acquired (S95). It is assumed that the host raise-hand responding process is executed by the terminal apparatus 41. In this case, the user operating the terminal apparatus 41 (the host user) may permit or prohibit speaking of the user operating the terminal apparatus having transmitted the raise-hand notification (the requesting user) in response to a request for the raise-hand function (see S13:Yes and S15 of FIG. 4). The host user operates the operating device 51 to press the raise-hand image 66 displayed in the raise-hand displaying process executed in S49 of FIG. 6. When the host raise-hand responding process is executed by the terminal apparatus 41, the participant process shown in FIG. 4 is executed by one of the terminal apparatuses 42, 43, 44, and 45. In this case, the requesting user is the user who operates one of the terminal apparatuses 42, 43, 44, and 45 having transmitted the raise-hand notification.

For example, the host user presses the raise-hand image 66 once when permitting speaking, and presses the raise-hand image 66 twice successively when not permitting speaking. The permission or non-permission of speaking may be specified by a different element from a press operation. For example, the permission or non-permission of speaking may be specified by displaying each of a raise-hand image associated with permission and a raise-hand image associated with non-permission and determining which raise-hand image is pressed. When a press of the raise-hand image 66 of the process target is received by the operating device 51, the CPU 47 acquires the raise-hand responding instruction for the raise-hand corresponding to that raise-hand image 66.

When a raise-hand responding instruction of raise-hand of the process target has been acquired (S95: Yes), the CPU 47 controls transmission of a raise-hand responding notification (S97). The raise-hand responding notification is a notification indicating whether speaking is permitted or not permitted. When the number of press of the raise-hand image 66 is one, the raise-hand responding notification includes information indicating that speaking is permitted. When the number of press of the raise-hand image 66 is successive two times, the raise-hand responding notification includes information indicating that speaking is not permitted. Further, the raise-hand responding notification includes the terminal ID corresponding to the raise-hand of the process target. The terminal ID corresponding to the raise-hand is included in the raise-hand notification for which the raise-hand image 66 corresponding to the raise-hand of the process target is displayed in S63 or S65 of the raise-hand displaying process (see FIG. 7) executed in S49 of FIG. 6. The transmission destination is set to the server apparatus 20. The CPU 47 outputs, to the communicator 53, a transmission command of the raise-hand responding notification including the above-mentioned terminal ID. With this operation, the raise-hand responding notification is transmitted from the communicator 53 to the server apparatus 20. After executing S97, the CPU 47 returns the process to S91. After that, the CPU 47 repeatedly executes the process of S91 and thereafter.

<SOS Displaying Process>

The SOS displaying process executed in S55 of FIG. 6 will be described while referring to FIG. 10. The CPU 47 having started the SOS displaying process determines whether the face image 65 mentioned below is displayed in the teleconference screen 60 (S111). The face image 65 to be determined is the face image corresponding to video data including the terminal ID mentioned below. The above-mentioned terminal ID is included in the SOS notification acquired before starting the SOS displaying process (see S53:Yes of FIG. 6). The SOS notification is stored in the RAM 49 as described above (see S53:Yes of FIG. 6). In S111, the CPU 47 determines whether the display setting of the above-mentioned face image 65 is either display or non-display. The CPU 47 makes a positive determination in S111 when the setting of the face image 65 to be determined is “display” (S111: Yes), and makes a negative determination in S111 when the setting of the face image 65 to be determined is “non-display” (S111: No).

When determination is positive in S111 (S111: Yes), the CPU 47 controls to switch display from the face image 65 determined in S111 to the SOS image 67 (S113). That is, the CPU 47 outputs, to the display 50, a display command of displaying the SOS image 67 at the position where the above-mentioned face image 65 is displayed. With this operation, in the display 50, display of the teleconference screen 60 is switched from the state shown in the upper part of FIG. 3 to the state shown in FIG. 11.

When determination is negative in S111 (S111: No), the CPU 47 controls to display the SOS image 67 in pop-up (S115). That is, the CPU 47 outputs, to the display 50, a display command of displaying the SOS image 67 at a particular position. With this operation, in the display 50, the SOS image 67 is popped up at the particular position. The particular position at which the SOS image 67 is popped up is set appropriately at a position that does not overlap the displayed face image 65. In FIG. 11, the SOS image 67 that is popped up in this way is omitted from the drawing. In S113 or S115, information corresponding to the terminal ID included in the raise-hand notification may be displayed together with the display of the SOS image 67. For example, it is assumed that the raise-hand notification includes the terminal ID “USER B”. In this case, the SOS image 67 including texts “USER B” may be displayed. After executing S113 or S115, the CPU 47 ends the SOS displaying process.

<SOS Display Updating Process>

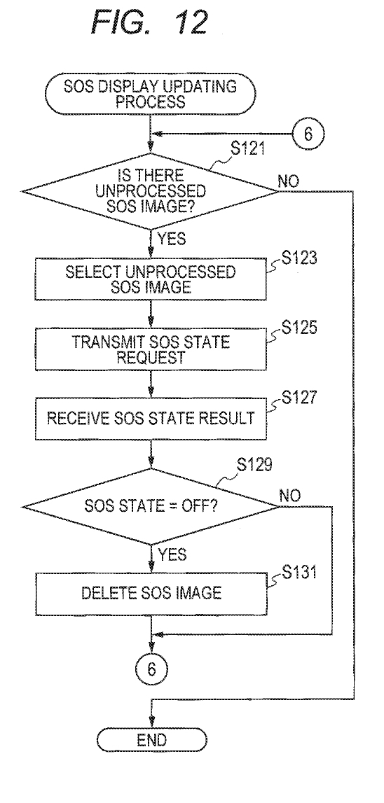

The SOS display updating process executed in S57 of FIG. 6 will be described while referring to FIG. 12. The CPU 47 having started the SOS display updating process determines whether there is unprocessed SOS image 67 in the SOS image 67 displayed in the teleconference screen 60 (S121). The unprocessed SOS image 67 is an SOS image that has not become the process target in S125 to S131.

When there is no unprocessed SOS image 67 (S121: No), the CPU 47 ends the SOS display updating process. When no SOS image 67 is displayed, there is no unprocessed SOS image 67 and hence determination is negative in S121 (S121: No).

When there is one or more unprocessed SOS image 67 (S121: Yes), the CPU 47 selects one unprocessed SOS image 67 as a process target (S123). Next, the CPU 47 controls transmission of an SOS state request (S125). The SOS state request is an instruction of requesting transmission of the SOS state that is managed by the server apparatus 20. The SOS state request includes the terminal ID corresponding to the SOS image 67 of the process target and the terminal ID of the user's own apparatus. The terminal ID corresponding to the SOS image 67 is included in the SOS notification for which the SOS image 67 of the process target is displayed in S113 or S115 of the SOS displaying process (see FIG. 7) executed in S55 of FIG. 6. The transmission destination is set to the server apparatus 20. The CPU 47 outputs, to the communicator 53, a transmission command of the SOS state request including the above-described terminal ID. With this operation, the SOS state request is transmitted from the communicator 53 to the server apparatus 20.

Next, the CPU 47 acquires an SOS state result (S127). The SOS state result includes the SOS state corresponding to the terminal ID included in the SOS state request. The above-mentioned terminal ID corresponds to the SOS image 67 of the process target out of the above-mentioned two terminal IDs. The SOS state result is transmitted from the server apparatus 20 in S183 of FIG. 15, and is received by the communicator 53. The CPU 47 acquires the SOS state result through the communicator 53. Next, the CPU 47 determines whether the SOS state included in the acquired SOS state result is “OFF” (S129). When the SOS state is “OFF” (S129: Yes), the CPU 47 controls deletion of the SOS image 67 of the process target (S131). That is, the CPU 47 outputs, to the display 50, a deletion command of the SOS image 67 of the process target. With this operation, in the display 50, the SOS image 67 of the process target is hidden (non-display). It can be said that, based on deletion of the SOS image 67 in S131, the

SOS state result including the SOS state “OFF” is a notification indicative of cancellation of the SOS function based on the SOS notification.

When the SOS state is not “OFF” but “ON” (S129: No) or after S131 is executed, the CPU 47 returns the process to S121. After that, the CPU 47 repeatedly executes the process of S121 and thereafter.

<Host SOS Responding Process>

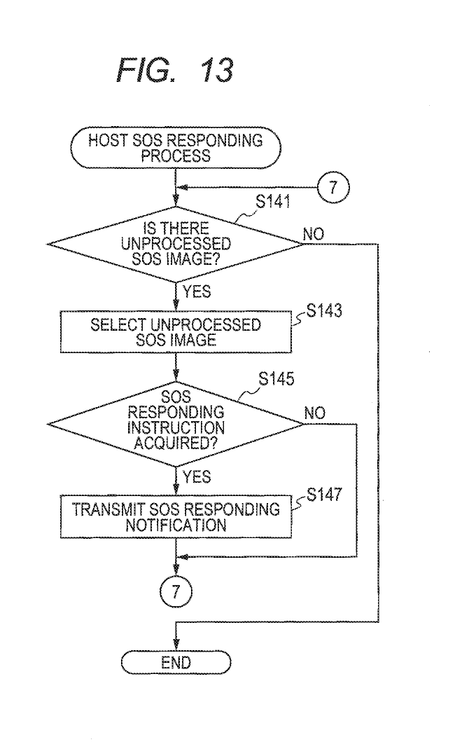

The host SOS responding process executed in S45 of FIG. 6 will be described while referring to FIG. 13. The CPU 47 having started the host SOS responding process determines whether there is unprocessed SOS in the SOS corresponding to the SOS image 67 displayed in the teleconference screen 60 (S141).

The unprocessed SOS is SOS that has not become the process target in S145 and S147. When there is no unprocessed SOS (S141: No), the CPU 47 ends the host SOS responding process. When the SOS image 67 is not displayed, there is no unprocessed SOS and hence determination is negative in S141 (S141: No).

When there is one or more unprocessed SOS (S141: Yes), the CPU 47 selects one unprocessed SOS as a process target (S143). Next, the CPU 47 determines whether an SOS responding instruction for the SOS of the process target has been acquired (S145). It is assumed that the host SOS responding process is executed by the terminal apparatus 41. In response to a request for the SOS function, the user operating the terminal apparatus 41 (the host user) operates the operating device 51 to press the SOS image 67 displayed in the SOS displaying process executed in S55 of FIG. 6. In response to this operation, the host user can start chat with the user (the requesting user) who operates the terminal apparatus having transmitted the SOS notification (see S17:Yes and S19 of FIG. 4). When the host SOS responding process is executed by the terminal apparatus 41, the participant process shown in FIG. 4 is executed by one of the terminal apparatuses 42, 43, 44, and 45. Accordingly, the above-mentioned requesting user is the user who operates one of the terminal apparatuses 42, 43, 44, and 45 having transmitted the SOS notification. When a press of the SOS image 67 of the process target has been received by the operating device 51, the CPU 47 acquires an SOS responding instruction for the SOS corresponding to that SOS image 67.

When the SOS responding instruction for SOS of the process target has been acquired (S145: Yes), the CPU 47 controls transmission of an SOS responding notification (S147). The SOS responding notification is a notification indicative of a response to a usage request for the SOS function. The SOS responding notification includes two terminal IDs. One of the two terminal IDs is the terminal ID of the user's own apparatus that is the transmission source of the SOS responding notification. The other one of the two terminal IDs is the terminal ID corresponding to the SOS of the process target. The terminal ID corresponding to the SOS is included in the SOS notification for which the SOS image 67 corresponding to the SOS of the process target is displayed in S113 or S115 of the SOS displaying process (see FIG. 10) executed in S55 of FIG. 6. The transmission destination is set to the server apparatus 20. The CPU 47 outputs, to the communicator 53, a transmission command of the SOS responding notification including the above-mentioned terminal ID. With this operation, the SOS responding notification is transmitted from the communicator 53 to the server apparatus 20. After executing S147, the CPU 47 returns the process to S141. After that, the CPU 47 repeatedly executes the process of S141 and thereafter.

<Process Executed by Server Apparatus>

Each process executed by the server apparatus 20, when a teleconference is conducted by the terminal apparatuses 41, 42, 43, 44, and 45, will be described. As described above, each of the terminal apparatuses 41, 42, 43, 44, and 45 establishes a session with the server apparatus 20 when connecting to the teleconference identified by the conference ID. The server apparatus 20 conducts the teleconference with the terminal apparatus for which a session is established.

In the embodiment, conducting a teleconference means executing particular processes for realizing a teleconference by the terminal apparatuses 41, 42, 43, 44, and 45. For example, by conducting a teleconference, the server apparatus 20 transmits and receives audio data in accordance with audio setting stored in the database, and transmits and receives video data in accordance with video setting. In response to starting the teleconference, or in a particular timing after the teleconference is started, the server apparatus 20 starts a server process shown in FIG. 14. The server process is executed in parallel with the teleconference. In some descriptions of processes executed by the server apparatus 20, when the terminal apparatuses 41, 42, 43, 44, and 45 are not differentiated from one another and one or a plurality of apparatuses are taken as an example, the terminal apparatuses 41, 42, 43, 44, and 45 are merely referred to as “terminal apparatus”.

<Server Process>

The server process will be described while referring to FIGS. 14 and 15. The CPU 21 having started the server process determines whether the teleconference identified by the terminal IDs of the terminal apparatuses 41, 42, 43, 44, and 45 has been finished (S151). In S151, the CPU 21 determines whether all the sessions established with the terminal apparatuses 41, 42, 43, 44, and 45 are disconnected. When all the session is disconnected, the CPU 21 determines that the teleconference is finished. When a session is established with at least one of the terminal apparatuses 41, 42, 43, 44, and 45, the CPU 21 determines that the teleconference is not finished. The CPU 21 requests a process of the main program in the teleconference to provide an establishment state of a session. The CPU 21 acquires a response to this request from the above-mentioned process. The CPU 21 determines the establishment state of the session based on this response. When the teleconference is finished (S151: Yes), the CPU 21 ends the server process.

When the teleconference is not finished (S151: No), the CPU 21 determines whether a raise-hand notification has been received (S153). The raise-hand notification is transmitted in S15 of FIG. 4. The raise-hand notification is received by the communicator 24. The CPU 21 acquires the raise-hand notification through the communicator 24. When the raise-hand notification has been received (S153: Yes), the CPU 21 executes a raise-hand determining process (S155). The raise-hand determining process will be described later. Next, the CPU 21 controls transmission of the raise-hand notification (S157). The CPU 21 accesses the database. In the database, the CPU 21 acquires raise-hand notification destination associated with the terminal ID included in the acquired raise-hand notification. The raise-hand notification destination is the terminal ID of the terminal apparatus that is the transmission destination of the raise-hand notification. The transmission destination is set to the terminal apparatus of the terminal ID that is acquired as the raise-hand notification destination.

For example, it is assumed that the terminal ID included in the acquired raise-hand notification is “USER A” and that the database is a storage state shown in FIG. 2. In this case, the transmission destination is set to the terminal apparatuses 42, 43, 44, and 45 of the terminal IDs “USER B”, “USER C”, “USER D”, and “USER E” that are the raise-hand notification destination associated with the terminal ID “USER A”. The CPU 21 outputs a transmission command of the raise-hand notification to the communicator 24. With this operation, the raise-hand notification is transmitted from the communicator 24 to the terminal apparatuses of the terminal IDs that are acquired as the raise-hand notification destination.

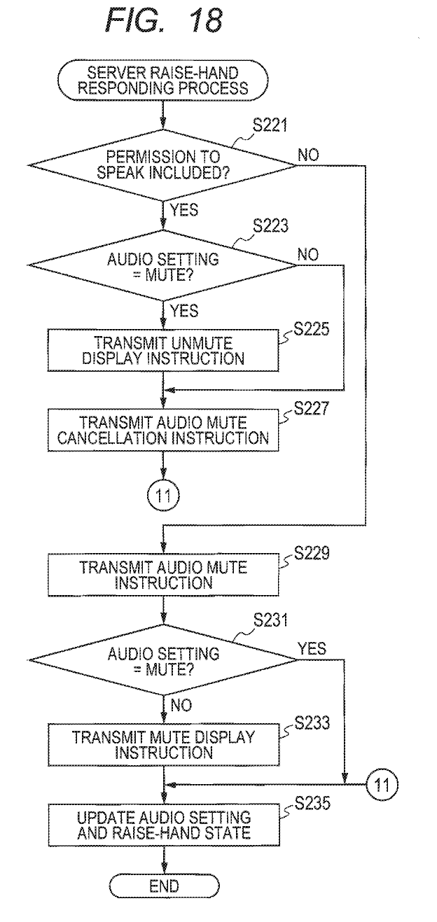

After executing S157, the CPU 21 updates the raise-hand state stored in the database to “ON” (S158). The raise-hand state to be updated is the raise-hand state stored in the database in association with the terminal ID included in the acquired raise-hand notification. The raise-hand state is state information indicative of whether usage of the raise-hand function is requested or the raise-hand function is cancelled. When usage of the raise-hand function is requested, that is, when a raise-hand notification has been acquired at a particular terminal apparatus, as described above, the raise-hand state of the terminal ID of that terminal apparatus is “ON”. In response to cancellation of the raise-hand function, the raise-hand state becomes “OFF” (see S235 of FIG. 18 described later).

When the raise-hand notification has not been acquired (S153: No) or after S158 is executed, the CPU 21 determines whether an SOS notification has been received (S159). The SOS notification is transmitted in S19 of FIG. 4. The SOS notification is received by the communicator 24. The CPU 21 acquires the SOS notification through the communicator 24. When the SOS notification has been acquired (S159: Yes), the CPU 21 executes an SOS determining process (S161). The SOS determining process will be described later.

Next, the CPU 21 controls transmission of the SOS notification (S163). The CPU 21 accesses the database. The CPU 21 acquires, in the database, the SOS notification destination associated with the terminal ID included in the received SOS notification. The SOS notification destination is the terminal ID of the terminal apparatus that is the transmission destination of the SOS notification. The transmission destination is set to the terminal apparatus of the terminal ID acquired as the SOS notification destination and the terminal apparatus of the terminal ID included in the SOS notification. For example, it is assumed that the terminal ID included in the received raise-hand notification is “USER B” and that the database is a storage state shown in FIG. 2. In this case, the transmission destination is set to the terminal ID “USER E” that is the SOS notification destination associated with the terminal ID “USER B”. The CPU 21 outputs a transmission command of the SOS notification to the communicator 24. With this operation, the SOS notification is transmitted from the communicator 24 to the terminal apparatus of the terminal ID that is acquired as the SOS notification destination.

After executing S163, the CPU 21 updates the SOS state stored in the database to “ON” (S164). The SOS state to be updated is the SOS state stored in the database in association with the terminal ID included in the received SOS notification. The SOS state is state information indicative of whether usage of the SOS function is requested or the SOS function is cancelled. When usage of the SOS function is requested, that is, when an SOS notification has been received from a particular terminal apparatus, as described above, the SOS state of the terminal ID of that terminal apparatus is “ON”. In response to cancellation of the SOS function, the SOS state becomes “OFF” (see S245 of FIG. 19 described later). After that, the CPU 21 moves the process to S165 of FIG. 15.

In S165, the CPU 21 determines whether the raise-hand responding notification has been received. The raise-hand responding notification is transmitted in S97 of FIG. 9. The raise-hand responding notification is received by the communicator 24. The CPU 21 acquires the raise-hand responding notification through the communicator 24. When the raise-hand responding notification is received (S165: Yes), the CPU 21 executes a server raise-hand responding process (S167). The server raise-hand responding process will be described later. When the raise-hand responding notification is not received (S165: No) or S167 is executed, the CPU 21 determines whether the SOS responding notification has been received (S169). The SOS responding notification is transmitted in S147 of FIG. 13. The SOS responding notification is received by the communicator 24. The CPU 21 acquires the SOS responding notification through the communicator 24. When the SOS responding notification is received (S169: Yes), the CPU 21 executes a server SOS responding process (S171). The server SOS responding process will be described later.

When the SOS responding notification has not been received (S169: No) or after S171 is executed, the CPU 21 determines whether a raise-hand state request has been received (S173). The raise-hand state request is transmitted in S75 of FIG. 8. The raise-hand state request is received by the communicator 24. The CPU 21 acquires the raise-hand state request through the communicator 24. When the raise-hand state request has been received (S173: Yes), the CPU 21 acquires the raise-hand state (S175). The raise-hand state to be acquired is the raise-hand state stored in the database in association with the terminal ID included in the raise-hand state request. The raise-hand state request includes two terminal IDs as described above. The terminal ID included in the above-mentioned raise-hand state request is a terminal ID different from the terminal ID of the terminal apparatus that is the transmission source of the raise-hand state request, out of the two terminal IDs included in the raise-hand state request. In descriptions of the server process, the terminal ID different from the terminal ID of the terminal apparatus that is the transmission source of the raise-hand state request is referred to as “target terminal ID of raise-hand state request”. In other words, the target terminal ID of the raise-hand state request is the terminal ID corresponding to the raise-hand image 66 that is the process target in S73 of FIG. 8. The CPU 21 accesses the database, and acquires the raise-hand state associated with the target terminal ID of the raise-hand state request.

The CPU 21 controls transmission of the raise-hand state result (S177). The raise-hand state result includes the raise-hand state acquired in S175 and the target terminal ID of the raise-hand state request. The transmission destination is set to the terminal apparatus of the terminal ID indicative of the transmission source of the raise-hand state request. The CPU 21 outputs a transmission command of the raise-hand state result to the communicator 24. With this operation, the raise-hand state result is transmitted from the communicator 24 to the terminal apparatus of the transmission source of the raise-hand state request.

When the raise-hand state request has not been received (S173: No) or after S177 is executed, the CPU 21 determines whether a SOS state request has been received (S179). The SOS state request is transmitted in S125 of FIG. 12. The SOS state request is received by the communicator 24. The CPU 21 acquires the SOS state request through the communicator 24. When the SOS state request has been received (S179: Yes), the CPU 21 acquires the SOS state (S181). The SOS state to be acquired is the SOS state stored in the database in association with the terminal ID included in the SOS state request. The SOS state request includes two terminal IDs as described above. The terminal ID included in the above-mentioned SOS state request is a terminal ID different from the terminal ID of the terminal apparatus that is the transmission source of the SOS state request, out of the two terminal IDs included in the SOS state request. In descriptions of the server process, the terminal ID different from the terminal ID of the terminal apparatus that is the transmission source of the SOS state request is referred to as “target terminal ID of SOS state request”. In other words, the target terminal ID of the SOS state request is the terminal ID corresponding to the SOS image 67 that is the process target in S123 of FIG. 12. The CPU 21 accesses the database, and acquires the SOS state associated with the target terminal ID of the SOS state request.

The CPU 21 controls transmission of the SOS state result (S183). The SOS state result includes the SOS state acquired in S181 and the target terminal ID of the SOS state request. The transmission destination is set to the terminal apparatus of the terminal ID indicative of the transmission source of the SOS state request. The CPU 21 outputs a transmission command of the SOS state result to the communicator 24. With this operation, the SOS state result is transmitted from the communicator 24 to the terminal apparatus of the transmission source of the SOS state request. When the SOS state request has not been received (S179: No) or after S183 is executed, the CPU 21 returns the process to S151 of FIG. 14. After that, the CPU 21 repeatedly executes the processes of S151 and thereafter.

<Raise-Hand Determining Process>

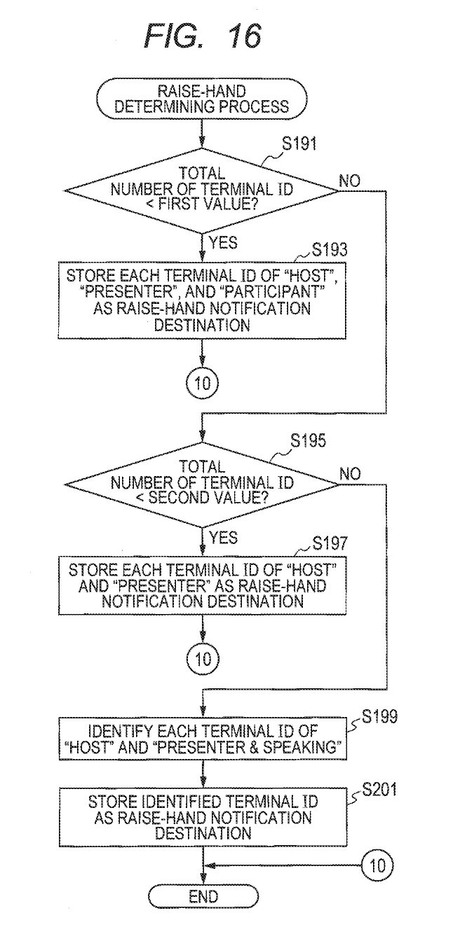

The raise-hand determining process executed in S155 of FIG. 14 will be described while referring to FIG. 16. The CPU 21 having started the raise-hand determining process determines whether the total number of the terminal ID is smaller than a first value (S191). The CPU 21 accesses the database and acquires the total number of the stored terminal IDs. The acquired total number of the terminal IDs is stored in the RAM 23. In the embodiment based on the teleconference by the terminal apparatuses 41, 42, 43, 44, and 45, the CPU 21 acquires “5” from the database as the total number of the terminal IDs. The first value is appropriately determined by considering various conditions. For example, the first value is determined as “6”. The first value is included in the program of the raise-hand determining process. The CPU 21 compares the acquired total number of the terminal IDs with the first value. Here, the total number of the terminal IDs is an example of “conference mode information”.

When the total number of the terminal IDs is smaller than the first value (S191: Yes), the CPU 21 stores, in the database, the terminal ID of the authority “host”, the terminal ID of the authority “presenter”, and the terminal ID of the authority “participant”, as the raise-hand notification destination associated with the terminal ID included in the raise-hand notification (see S153: Yes of FIG. 14) that is acquired before starting the raise-hand determining process (S193). The terminal ID of the terminal apparatus of the transmission source of this notification, included in the raise-hand notification is excluded from the raise-hand notification destination. For example, it is assumed that the terminal ID “USER A” is included in the raise-hand notification. In this case, “USER B” and “USER C” (authority: participant), “USER D” (authority: presenter), and “USER E” (authority: host) are stored as the raise-hand notification destination, in association with the terminal ID “USER A”.

When the total number of the terminal IDs is larger than or equal to the first value (S191: No), the CPU 21 determines whether the total number of the terminal IDs is smaller than a second value (S195). The second value is set to a particular value larger than the first value. For example, the second value is set to “10”. The second value is included in the program of the raise-hand determining process. The CPU 21 compares the total number of the terminal IDs stored in the RAM 23 with the second value.

When the total number of the terminal IDs is smaller than the second value (S195: Yes), the CPU 21 stores, in the database, the terminal ID of the authority “host” and the terminal ID of the authority “presenter” (regardless of the speaking state of the “presenter”), as the raise-hand notification destination associated with the terminal ID included in the raise-hand notification that is acquired before starting the raise-hand determining process (S197).

When the total number of the terminal IDs is larger than or equal to the second value (S195: No), the CPU 21 identifies the following two types of terminal IDs (S199). A first type of terminal ID is a terminal ID having the authority “host”. A second type of terminal ID is a terminal ID having the authority “presenter” and the speaking state “speaking”. When identifying the first type of terminal ID and the second type of terminal ID, the CPU 21 accesses the database and extracts the terminal ID satisfying each condition described above. Next, the CPU 21 stores, in the database, the above-described first type of terminal ID and second type of terminal ID, as the raise-hand notification destination associated with the terminal ID included in the raise-hand notification that is acquired before starting the raise-hand determining process (S201).

After executing S193, S197 or S201, the CPU 21 ends the raise-hand determining process.

<SOS Determining Process>

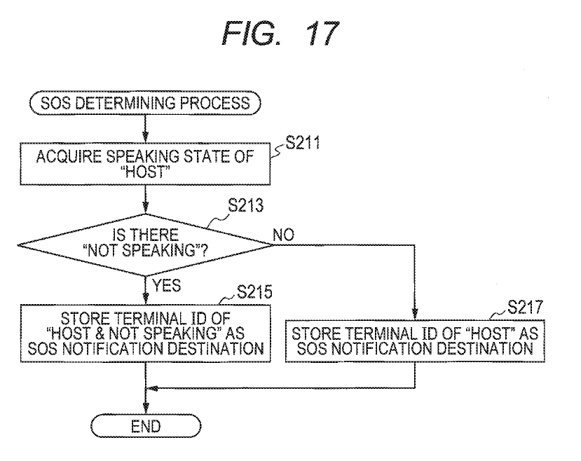

The SOS determining process executed in S161 of FIG. 14 will be described while referring to FIG. 17. The CPU 21 having started the SOS determining process accesses the database, and acquires the speaking state associated with the terminal ID having the authority “host” (S211). Next, the CPU 21 determines whether there is “not speaking” as the acquired speaking state (S213).

When there is “not speaking” as the speaking state (S213: Yes), the CPU 21 stores, in the database, the terminal ID having the authority “host” and the speaking state “not speaking”, as the SOS notification destination associated with the terminal ID included in the SOS notification (see S159:Yes of FIG. 14) that is acquired before starting the SOS determining process (S215). When there is no “not speaking” as the speaking state (S213: No), the CPU 21 stores, in the database, the terminal ID having the authority “host”, as the SOS notification destination associated with the terminal ID included in the SOS notification that is acquired before starting the SOS determining process (S217). After executing S215 or S217, the CPU 21 ends the SOS determining process.

<Server Raise-Hand Responding Process>

The server raise-hand responding process executed in S167 of FIG. 15 will be described while referring to FIG. 18. The CPU 21 having started the server raise-hand responding process determines whether the raise-hand responding notification acquired before starting the server raise-hand responding process (see S165:Yes of FIG. 15) includes information indicating that speaking is permitted (S221). When the raise-hand responding notification includes information indicating that speaking is not permitted and does not include information indicating that speaking is permitted (S221:No), the CPU 21 moves the process to S229.

When the raise-hand responding notification includes information indicating that speaking is permitted (S221: Yes), the CPU 21 determines whether audio setting associated with the terminal ID mentioned below is “Mute” (S223). The above-mentioned terminal ID is included in the raise-hand responding notification together with information indicating that speaking is permitted. In S223, the CPU 21 accesses the database and makes the above-described determination.

When the audio setting is “Mute” (S223: Yes), the CPU 21 controls transmission of an unmute display instruction (S225). The unmute display instruction includes the terminal ID included in the raise-hand responding notification. The unmute display instruction is a switch instruction of switching, to the unmute image 69, from the mute image 70 that is displayed so as to correspond to the face image 65 of the terminal apparatus of the above-mentioned terminal ID. The transmission destination is set to the terminal apparatuses 41, 42, 43, 44, and 45 of all the terminal IDs stored in the database. However, the terminal apparatus of the terminal ID included in the raise-hand responding notification, that is, the terminal ID included in the unmute display instruction may be excluded from the transmission destination. The CPU 21 outputs a transmission command of the unmute display instruction to the communicator 24. With this operation, the unmute display instruction is transmitted from the communicator 24 to all or a part of the terminal apparatuses 41, 42, 43, 44, and 45 set as the transmission destination.

Although details are omitted, the terminal apparatus having received the unmute display instruction controls display based on the unmute display instruction.

That is, in this terminal apparatus, a display command is outputted to the display 50. The display command is a command of switching, to the unmute image 69, from the mute image 70 that is displayed so as to correspond to the face image 65 of the terminal apparatus of the terminal ID included in the unmute display instruction. With this operation, in the display 50, the mute image 70 displayed so as to correspond to the above-mentioned face image 65, in the teleconference screen 60 that is being displayed, is switched to the unmute image 69. When the above-mentioned face image 65 is not displayed, this display control is not executed.

When the audio setting is not “Mute” but “Unmute” (S223: No) or after S225 is executed, the CPU 21 controls transmission of an audio mute cancellation instruction (S227). The audio mute cancellation instruction is an instruction of permitting transmission of audio data corresponding to sound collected by the terminal apparatus that is the transmission destination of this instruction. The transmission destination is set to the terminal apparatus of the terminal ID included in the raise-hand responding notification determined in S221. The CPU 21 outputs a transmission command of the audio mute cancellation instruction to the communicator 24. With this operation, the audio mute cancellation instruction is transmitted from the communicator 24 to the above-mentioned terminal apparatus. After that, the CPU 21 moves the process to S235.

Although details are omitted, in the terminal apparatus having received the audio mute cancellation instruction, for example, a screen including information that transmission is permitted is popped up in teleconference screen 60. In the embodiment, the above-mentioned screen is omitted in the drawings. This terminal apparatus starts transmission of audio data (audio packet) to the server apparatus 20 through the established session.

In S229, the CPU 21 controls transmission of an audio mute instruction. The audio mute instruction is an instruction of not permitting transmission of audio data corresponding to sound collected by the terminal apparatus that is the transmission destination of this instruction. The transmission destination is set to the terminal apparatus of the terminal ID included in the raise-hand responding notification determined in S221. The CPU 21 outputs a transmission command of the audio mute instruction to the communicator 24. With this operation, the audio mute instruction is transmitted from the communicator 24 to the above-mentioned terminal apparatus.

Although details are omitted, in the terminal apparatus having received the audio mute instruction, for example, a screen including information that transmission is not permitted is popped up in the teleconference screen 60. In the embodiment, the above-mentioned screen is omitted in the drawings. This terminal apparatus does not transmit audio data (audio packet) to the server apparatus 20 through the established session.

After executing S229, the CPU 21 determines whether audio setting associated with the terminal ID mentioned below is “Mute” (S231). The above-mentioned terminal ID is included in the raise-hand responding notification together with information indicating that speaking is not permitted. In S231, the CPU 21 accesses the database and makes the above-described determination.

When the audio setting is not “Mute” but “Unmute” (S231: No), the CPU 21 controls transmission of a mute display instruction (S233). The mute display instruction includes the terminal ID included in the raise-hand responding notification. The mute display instruction is a switch instruction of switching, to the mute image 70, from the unmute image 69 that is displayed so as to correspond to the face image 65 of the terminal apparatus of the above-mentioned terminal ID. The transmission destination is set to the terminal apparatuses 41, 42, 43, 44, and 45 of all the terminal IDs stored in the database. However, the terminal apparatus of the terminal ID included in the raise-hand responding notification, that is, the terminal ID included in the mute display instruction may be excluded from the transmission destination. The CPU 21 outputs a transmission command of the mute display instruction to the communicator 24. With this operation, the mute display instruction is transmitted from the communicator 24 to all or a part of the terminal apparatuses 41, 42, 43, 44, and 45 set as the transmission destination.

Although details are omitted, the terminal apparatus having received the mute display instruction controls display based on the mute display instruction. That is, in this terminal apparatus, a display command is outputted to the display 50. The display command is a command of switching, to the mute image 70, from the unmute image 69 that is displayed so as to correspond to the face image 65 of the terminal apparatus of the terminal ID included in the mute display instruction. With this operation, in the display 50, the unmute image 69 displayed so as to correspond to the above-mentioned face image 65, in the teleconference screen 60 that is being displayed, is switched to the mute image 70. When the above-mentioned face image 65 is not displayed, this display control is not executed.

When the audio setting is “Mute” (S231: Yes) or after S233 is executed, the CPU 21 moves the process to S235. In S235, the CPU 21 updates the audio setting and the raise-hand state stored in the database. The audio setting and the raise-hand state to be updated are the audio setting and the raise-hand state associated with the terminal ID included in the raise-hand responding notification determined in S221. That is, when the raise-hand responding notification includes information indicating that speaking is permitted, the above-mentioned audio setting is updated to “Unmute”. When “Unmute” is already stored, this update may be omitted. On the other hand, when the raise-hand responding notification includes information indicating that speaking is not permitted, the above-mentioned audio setting is updated to “Mute”. When “Mute” is already stored, this update may be omitted. The raise-hand state is updated to “OFF”. After that, the CPU 21 ends the server raise-hand responding process.

<Server SOS Responding Process>

The server SOS responding process executed in S171 of FIG. 15 will be described while referring to FIG. 19. The CPU 21 having started the server SOS responding process starts a chat process (S241). The CPU 21 starts up the program of the chat process stored in the storage 22. With this operation, the chat process is started in the server apparatus 20. The target of chat is each terminal apparatus of two terminal IDs included in the SOS responding notification (see S169:Yes of FIG. 15) acquired before starting the server SOS responding process. Next, the CPU 21 controls transmission of a chat start instruction (S243). The chat start instruction is an instruction of starting chat at each terminal apparatus of the transmission destination of this instruction. The transmission destination is set to each terminal apparatus of the above-mentioned two terminal IDs.

Although details are omitted, each terminal apparatus receives the chat start instruction. In response to this, the chat screen 68 is displayed in the teleconference screen 60 displayed at each terminal apparatus. At each terminal apparatus, the operating device is operated and receives input of characters. As described above, the character data corresponding to the received characters are transmitted and received between each terminal apparatus by the chat process that is being executed by the server apparatus 20.

Next, the CPU 21 updates the SOS state stored in the database to “OFF” (S245). The SOS state to be updated is the SOS state associated with the terminal ID of the terminal apparatus (authority: participant), not the terminal apparatus (authority: host) of the transmission source of the SOS responding notification, out of the above-mentioned two terminal IDs. After that, the CPU 21 ends the server SOS responding process.

### Effects of the Embodiment

According to the above-described embodiment, the following effects can be obtained.

(1) In the teleconference by the terminal apparatuses 41, 42, 43, 44, and 45 identified by the conference ID, the server apparatus 20 executes the server process shown in FIGS. 14 and 15. In the server process, the raise-hand notification transmitted from the terminal apparatus to which the authority “participant” is set (see S15 of FIG. 4) is acquired (see S153:Yes of FIG. 14), and the raise-hand determining process is executed (see S155 of FIG. 14). In the raise-hand determining process shown in FIG. 16, when the total number of the terminal ID is smaller than the first value (see S191:Yes of FIG. 16), the terminal ID of the authority “host”, the terminal ID of the authority “presenter”, and the terminal ID of the authority “participant” are stored in the database, as the raise-hand notification destination associated with the terminal ID included in the raise-hand notification (see S193 of FIG. 16). When the total number of the terminal ID is larger than the first value (see S191:No of FIG. 16), the terminal ID of the authority “host” and the terminal ID of the authority “presenter” are stored in the database, as the raise-hand notification destination associated with the terminal ID included in the raise-hand notification (see S197 or S199 of FIG. 16). In this case (see S191:No of FIG. 16), the terminal ID of the authority “participant” is not stored as the raise-hand notification destination.

Hence, in the teleconference identified by the conference ID, depending on the number of the terminal IDs stored in the database, the transmission destination of the raise-hand notification can be set appropriately to each terminal apparatus of “host”, “presenter”, and “participant” or each terminal apparatus of “host” and “presenter” out of the terminal apparatuses 41, 42, 43, 44, and 45. The transmission destination of the raise-hand notification can be flexibly determined depending on the situation of the teleconference.

(2) In the raise-hand determining process, when the total number of the terminal ID is larger than the first value (see S191:No of FIG. 16) and is larger than the second value (the second value >the first value) (see S195:No of FIG. 16), the raise-hand notification destination is limited to the terminal ID having the authority “host” and the terminal ID having the authority “presenter” and the speaking state “speaking” (see S201 of FIG. 16). Hence, in a large-scale teleconference, the raise-hand notification is transmitted to the terminal apparatus that is operated by the speaking user, out of the terminal apparatuses to which the authority “presenter” is set. For example, it is possible to notify the speaking user (presenter) that there is a user who has a question or the like for the presentation and who is requesting speaking (see S35 of FIG. 5 and S63 or S65 of FIG. 7).

(3) In the server process, the SOS notification transmitted from the terminal apparatus to which the authority “participant” is set (see S19 of FIG. 4) is acquired (see S159:Yes of FIG. 14), and the SOS determining process is executed (see S161 of FIG. 14). In the SOS determining process shown in FIG. 17, the terminal ID having the authority “host” is stored in the database, as the SOS notification destination associated with the terminal ID included in the SOS notification (see S215 or S217 of FIG. 17). Here, in the SOS determining process, the terminal ID having the speaking state “not speaking” is stored in priority to the other terminal IDs. That is, when there is a terminal ID having the authority “host” and the speaking state “not speaking”, only that terminal ID is stored in the database as the SOS notification destination (see S215 of FIG. 17). However, it is presumed that all of the terminal IDs having the authority “host” are “speaking”. In this case, all of the terminal IDs having the authority “host” are stored in the database as the SOS notification destination (see S217 of FIG. 17). In the SOS determining process, the terminal ID having authority “presenter” or “participant” is not stored as the SOS notification destination.

Hence, in response to a request for usage of the SOS function, it is possible to notify the user who is not speaking, in priority to the other users, out of the users operating the terminal apparatus having the authority “host”, that there is a user who is requesting usage of the SOS function (see S113 or S115 of FIG. 10). The user having a role of “host” in the teleconference deals with chat. When the user who operates the terminal apparatus having the authority “host” is speaking, it is likely that this user is the facilitator of the teleconference. By giving the above-described notification to the user who operates the terminal apparatus having the authority “host” and is not speaking in priority to the other users, it is possible to support users who operate the terminal apparatus having the authority “participant” without hindering the progress of the teleconference. When there is no user who operates the terminal apparatus having the authority “host” and is not speaking, the SOS notification is transmitted to all the terminal apparatuses having the authority “host”. The user who has a role of the host in the teleconference can be notified that there is a user who is requesting usage of the SOS function (see S113 or S115 of FIG. 10).

(4) In the server process, when the raise-hand responding notification is acquired from the terminal apparatus of the terminal ID having the authority “host” (see S97 of FIGS. 9 and S165:Yes of FIG. 15), the server raise-hand responding process is executed (see S167 of FIG. 15). In the server raise-hand responding process shown in FIG. 18, when the acquired raise-hand responding notification includes information indicating that speaking is permitted (see S221:Yes of FIG. 18), the audio mute cancellation instruction is transmitted to the terminal apparatus of the terminal ID included in the raise-hand responding notification determined in S221 (see S227 of FIG. 18). When the acquired raise-hand responding notification does not include the above-mentioned information but includes information indicating that speaking is not permitted (see S221:No of FIG. 18), the audio mute instruction is transmitted to the above-mentioned terminal apparatus (see S229 of FIG. 18). Hence, the terminal apparatus of the transmission source of the raise-hand notification (authority: participant, see S15 of FIG. 4) can be notified about whether speaking is permitted. This terminal apparatus displays, in the teleconference screen 60, a screen including information that transmission is permitted or a screen including information that transmission is not permitted.

In the server raise-hand responding process, after the audio mute cancellation instruction or the audio mute instruction is transmitted, the raise-hand state stored in the database is updated to “OFF” (see S235 of FIG. 18). The raise-hand state to be updated is the raise-hand state associated with the terminal ID included in the raise-hand responding notification determined in S221. In the server process, the updated raise-hand state “OFF” is transmitted to the terminal apparatuses 41, 42, 43, 44, and 45 (see S177 of FIG. 15). Hence, the raise-hand image 66 displayed in each terminal apparatus becomes undisplayed (see S25 of FIG. 4, S37 of FIG. 5 or S57 of FIGS. 6, and S79:Yes and S81 of FIG. 8).

(5) The storage 22 of the server apparatus 20 stores the program of the chat process. In the server process, the server SOS responding process is executed (see S171 of FIG. 15). In the server SOS responding process shown in FIG. 19, the chat process is started (see S241 of FIG. 19), and the SOS state stored in the database is updated to “OFF” (see S245 of FIG. 19). The SOS state to be updated is the SOS state associated with the terminal ID having the authority “participant” out of the two terminal IDs included in the SOS responding notification. In the server process, the SOS state result including the updated SOS state “OFF” is transmitted to the terminal apparatus having the authority “host” (see S183 of FIG. 15). Hence, the SOS image 67 displayed in the terminal apparatus having the authority “host” becomes undisplayed (see S129:Yes and S131 of FIG. 12).

<Modifications>

While the disclosure has been described in detail with reference to the above aspects thereof, it would be apparent to those skilled in the art that various changes and modifications may be made therein without departing from the scope of the claims. Further, some configurations of modifications described below can be appropriately adopted in combination. In the following description, like parts and components are designated by the same reference numerals to avoid duplicating description.

(1) In the above-described embodiment, regarding the speaking state stored in the database (see FIG. 2), determination of whether the speaking state is “speaking” is performed based on whether the audio packet includes audio data or includes blank information in a header section. The determination of whether the speaking state is “speaking” may be performed as follows, for example. In this case, in the terminal apparatuses 41, 42, 43, 44, and 45, audio data is generated regardless of the level of collected sound, and the audio packet including this is transmitted to the server apparatus 20. The server apparatus 20 detects the level of sound corresponding to each audio data from the terminal apparatuses 41, 42, 43, 44, and 45, for example. Next, it is determined whether the level of detected sound is larger than a threshold. When the level of sound is larger than the threshold, it is determined that the speaking state is “speaking”. In this case, “speaking” is stored in the database in association with the terminal ID included in the audio data that is determined.

The audio data is obtained by performing A/D conversion on sound collected by the terminal apparatuses 41, 42, 43, 44, and 45 at a particular sampling frequency (for example, 11.025 kHz or 44.1 kHz). The audio data includes waveform data. Detection of the level is determined by detecting the level of waveform of sound corresponding to the audio data. The sound corresponding to the audio data includes a plurality of sampling points. Hence, for example, an average level of a plurality of sampling points in a particular period is detected as the level of sound. The highest level of the plurality of sampling points may be detected as the level of sound. The threshold serving as the determination criteria is preliminarily determined by considering the level of sound that is obtained when each user operating the terminal apparatuses 41, 42, 43, 44, and 45 is speaking in the teleconference. The threshold is stored in a program for determining whether the speaking state is “speaking”. For example, the threshold may be appropriately changed depending on a noise level of background in the sound collection environment, and so on.

(2) In the above-described embodiment, in S193 of the raise-hand determining process shown in FIG. 16, the terminal ID of the terminal apparatus of the transmission source of this notification, included in the raise-hand notification, is excluded from the raise-hand notification destination. In S193, the terminal ID of the terminal apparatus of the transmission source of the raise-hand notification may also be stored, as the raise-hand notification destination, in association with the terminal ID of the user's own apparatus. In this case, in S157 of the server process shown in FIGS. 14 and 15, the raise-hand notification is also transmitted to the terminal apparatus of the transmission source of the acquired raise-hand notification (see S153:Yes of FIG. 14). In this terminal apparatus, in accordance with the raise-hand notification from the server apparatus 20, the raise-hand displaying process is executed (see S21:Yes and S23 of FIG. 4) and the raise-hand image 66 is displayed (see S63 or S65 of FIG. 7).

(3) In the above-described embodiment, the determination condition of S79 of the raise-hand display updating process shown in FIG. 8 is “raise-hand state=OFF”. This determination condition may be changed to “raise-hand state=ON”.

When this determination is negative, the process moves to S81. When this determination is positive, the process returns to S71. The determination condition of S129 of the SOS display updating process shown in FIG. 12 is “SOS state=OFF”. This determination condition may be changed to “SOS state=ON”. When this determination is negative, the process moves to S131. When this determination is positive, the process returns to S121. Regarding the determination condition “the total number of terminal ID<the first value” of S191 and the determination condition “the total number of terminal ID<the second value” of S195 of the raise-hand determining process shown in FIG. 16, when the total number of the terminal ID is equal to the first value or the second value, positive determination may be made (see S191 or S195: Yes).

The determination condition of S223 and S231 of the server raise-hand responding process shown in FIG. 18 is “audio setting=Mute”. This determination condition may be changed to “audio setting=Unmute”. In S223, the process moves to S225 when this determination is negative, and the process moves to S227 when this determination is positive. In S231, the process moves to S233 when this determination is positive, and the process moves to S235 when this determination is negative.

(4) In the above-described embodiment, a particular notification or a particular instruction or particular data, transmitted to the server apparatus 20, includes the terminal ID of the terminal apparatus of the transmission source. For example, the raise-hand notification transmitted in S15 and the SOS notification transmitted in S19 of the participant process shown in FIG. 4 include the terminal ID of the user's own apparatus. Also, the raise-hand state request transmitted in S75 of the raise-hand display updating process shown in FIG. 8 and the SOS state request transmitted in S125 of the SOS display updating process shown in FIG. 12 include the terminal ID of the user's own apparatus. Further, the SOS responding notification transmitted in S147 of the host SOS responding process shown in FIG. 13 includes the terminal ID of the user's own apparatus. Addition of the terminal ID of the terminal apparatus of the transmission source may be omitted. The session established between the server apparatus 20 and each of the terminal apparatuses 41, 42, 43, 44, and 45 is unique to each of the terminal apparatuses 41, 42, 43, 44, and 45. Accordingly, when the above-described notification or instruction or data is received by the communicator 24, the server apparatus 20 identifies the session used for communication and thereby identifies the terminal ID of the terminal apparatus of the transmission source. Although details are omitted, the server apparatus 20 manages the identified terminal ID and appropriately executes control based on this. With this operation, the server apparatus 20 executes each process similar to the above.

(5) In the above-described embodiment, in the raise-hand determining process shown in FIG. 16, the total number of the terminal IDs is compared with the first value or the second value, and the raise-hand notification destination is appropriately stored in the database (see S193, S197 or S201 of FIG. 16). In the teleconference system 10, a conference mode may be set depending on the situation of the teleconference, and the conference mode may be determined in S191 and S195 of FIG. 16. The conference mode is associated with the conference ID, and the conference mode set to the teleconference is identified by the conference ID. The conference mode includes a group discussion mode, a presentation mode, and a normal mode, for example. The group discussion mode is a mode corresponding to a smallest-scale teleconference in the above-mentioned modes. In the group discussion mode, for example, a teleconference is started in a state where the audio setting and the video setting for all the terminal apparatuses having the authorities “host”, “presenter”, and “participant” are set to “Unmute” and “ON”, respectively. Although detailed descriptions are omitted in the above, settings relating to sharing of a document are only permitted to the terminal apparatus having the authority “host” at the time of starting a teleconference, for example.

The presentation mode is a mode corresponding to a largest-scale teleconference in the above-mentioned modes. In the presentation mode, for example, a teleconference is started in a state where the audio setting and the video setting for the terminal apparatuses having the authorities “host” and “presenter” are set to “Unmute” and “ON”, respectively, and where the audio setting and the video setting for the terminal apparatus having the authority “participant” are set to “Mute” and “OFF”, respectively. The settings relating to sharing of a document are only permitted to the terminal apparatus having the authority “host” at the time of starting a teleconference, for example. The normal mode is a mode for a teleconference having a scale between the group discussion mode and the presentation mode. In the normal mode, for example, a teleconference is started in a state where the audio setting and the video setting for all the terminal apparatuses having the authorities “host”, “presenter”, and “participant” are set to “Unmute” and “ON”, respectively. The settings relating to sharing of a document are only permitted to the terminal apparatus having the authority “host” at the time of starting a teleconference, for example. Here, the above-described conference mode is an example of “conference mode information”.

In S191 of FIG. 16, it is determined whether the conference mode is the group discussion mode. When the conference mode is the group discussion mode and this determination is positive (see S191: Yes), the process moves to S193. When the conference mode is not the group discussion mode and this determination is negative (see S191: No), the process moves to S195. When the conference mode is the presentation mode or the normal mode, determination is negative in S191 (see S191: No). In S195, it is determined whether the conference mode is the normal mode. When the conference mode is the normal mode and this determination is positive (see S195: Yes), the process moves to S197. When the conference mode is not the normal mode and this determination is negative (see S195: No), the process moves to S199. When the conference mode is not the normal mode, the conference mode is the presentation mode.

In the SOS determining process shown in FIG. 17, the SOS notification destination may be determined based on the conference mode. For example, it may be determined whether the conference mode is a particular mode of the above-described three modes and, when the conference mode is the particular mode, steps S211 to S217 of FIG. 17 may be executed. On the other hand, when the conference mode is not the particular mode, for example, a process similar to S217 may be executed directly.

(6) In the above-described embodiment, the teleconference screen 60 is the configuration shown in FIGS. 3 and 11. The teleconference screen may be the configuration shown in FIG. 20. In FIG. 20, in order to clarify the correspondence with the teleconference screen 60 shown in FIGS. 3 and 11, like parts and components are designated by the same reference numerals. That is, in the teleconference screen 60 shown in FIG. 20, a list 71 is displayed in addition to each configuration in the teleconference screen 60 shown in FIGS. 3 and 11. The list 71 includes information corresponding to the terminal IDs of the terminal apparatuses connecting to the teleconference identified by the conference ID, in association with the authorities. In the list 71, a raise-hand image 72 corresponding to the raise-hand image 66 is displayed in association with information corresponding to the terminal ID. Although illustration is omitted in FIG. 20, in the list 71, an SOS image corresponding to the SOS image 67 is also displayed in association with information corresponding to the terminal ID.

Further, in the list 71, the unmute image 69 or the mute image 70 depending on the audio setting is displayed in association with information corresponding to the terminal IDs. In the terminal apparatus, display of the unmute image 69 and the mute image 70 in the list 71 is switched in response to switching between the unmute image 69 and the mute image 70 displayed so as to correspond to the face image 65, the switching being performed in response to the unmute display instruction (see S225 of FIG. 18) and the mute display instruction (see S233 of FIG. 18) from the server apparatus 20. In the raise-hand image 72 displayed in the list 71, information corresponding to the terminal ID added to the raise-hand image 66 is omitted. In the SOS image displayed in the list 71, information corresponding to the terminal ID added to the SOS image 67 (see FIG. 11) is omitted.

In the host raise-hand responding process shown in FIG. 9, the raise-hand responding instruction is acquired in response to press of the raise-hand image 66 or the raise-hand image 72 (see S95:Yes of FIG. 9). That is, the host user presses the raise-hand image 66 or the raise-hand image 72 once for permitting speaking, and presses the raise-hand image 66 or the raise-hand image 72 twice successively for not permitting speaking. The permission or non-permission of speaking may be specified by a different element from a press operation, in a similar manner to the above. When press of the raise-hand image 66 or the raise-hand image 72 of the process target has been received by the operating device 51, the CPU 47 acquires the raise-hand responding instruction for the raise-hand corresponding to the raise-hand image 66 or the raise-hand image 72.

In the host SOS responding process shown in FIG. 13, the SOS responding instruction is acquired in response to press of the SOS image 67 or the SOS image of the list 71 (see S145:Yes of FIG. 13). That is, when responding to a request for usage of the SOS function, the host user presses the SOS image 67 or the SOS image of the list 71. When the press of the SOS image 67 or the SOS image of the list 71 of the process target has been received by the operating device 51, the CPU 47 acquires the SOS responding instruction for the SOS corresponding to the SOS image 67 or the SOS image of the list 71.

When the teleconference screen 60 includes the list 71, in the raise-hand displaying process shown in FIG. 7, the CPU 47 controls display of the raise-hand image 72 immediately after starting the raise-hand displaying process, for example. The terminal ID for which the raise-hand image 72 is displayed is included in the raise-hand notification (see S21 of FIG. 4, S33 of FIG. 5, S47:Yes of FIG. 6) acquired before starting the raise-hand displaying process. The CPU 47 outputs, to the display 50, a display command of displaying the raise-hand image 72 at a particular position corresponding to the above-mentioned terminal ID. With this operation, in the display 50, the raise-hand image 72 is displayed at the particular position. For example, the above-mentioned particular position is next to the information corresponding to the terminal ID in the list 71 (see FIG. 20).

When the teleconference screen 60 includes the list 71, in the SOS displaying process shown in FIG. 10, the CPU 47 controls display of the SOS image in the list 71 immediately after starting the SOS displaying process, for example. The terminal

ID for which the SOS image is displayed in the list 71 is included in the SOS notification (see S53:Yes of FIG. 6) acquired before starting the SOS displaying process. The CPU 47 outputs, to the display 50, a display command of displaying this SOS image at a particular position corresponding to the above-mentioned terminal ID. With this operation, in the display 50, the SOS image is displayed at the particular position in the list 71. For example, the above-mentioned particular position is next to the information corresponding to the terminal ID in the list 71. When both of the raise-hand image 72 and the SOS image are displayed in the list 71, the raise-hand image 72 and the SOS image are displayed next to each other in juxtaposition with the information corresponding to the terminal ID.

Although details are omitted, when the teleconference screen 60 includes the list 71, in S81 of the raise-hand display updating process shown in FIG. 8, the raise-hand image 72 corresponding to the raise-hand image 66 to be deleted is also deleted together with the above-mentioned raise-hand image 66. Similarly, in S131 of the SOS display updating process shown in FIG. 12, the SOS image of the list 71 corresponding to the SOS image 67 to be deleted is also deleted together with the above-mentioned SOS image 67.

What is claimed is:

1. A non-transitory computer-readable storage medium storing a program executable by a computer that controls a server apparatus configured to execute a teleconference conducted by a plurality of terminal apparatuses connected to a network, the program causing, when executed, the server apparatus to perform operations comprising:
a first receiving operation of receiving a first notification, through a communicator of the server apparatus connected to the network, from a first terminal apparatus out of the plurality of terminal apparatuses, a first authority being set to the first terminal apparatus, the first authority being one of authorities that are preliminarily set in the teleconference;
a first determining operation of determining a transmission destination of the first notification received by the first receiving operation based on conference mode information related to a total number of the plurality of terminal apparatuses connecting to the teleconference, the transmission destination being at least one of the plurality of terminal apparatuses; and
a first transmitting operation of transmitting the first notification from the communicator to the transmission destination determined by the first determining operation.

2. The storage medium according to claim 1, wherein the first determining operation comprises:
when the total number of the plurality of terminal apparatuses is smaller than a first value, determining a second terminal apparatus and a third terminal apparatus as the transmission destination of the first notification, the second terminal apparatus and the third terminal apparatus being ones of the plurality of terminal apparatuses, the second terminal apparatus being a terminal apparatus to which the first authority is set and being different from the first terminal apparatus, the third terminal apparatus being a terminal apparatus to which a second authority is set, the second authority being one of authorities that are preliminarily set in the teleconference and being authority of a higher level than the first authority; and
when the total number of the plurality of terminal apparatuses is larger than the first value, determining the third terminal apparatus as the transmission destination of the first notification without determining the second terminal apparatus as the transmission destination of the first notification.

3. The storage medium according to claim 2, wherein the program further causes, when executed, the server apparatus to perform operations comprising:
a first detecting operation of detecting a speaking state of a user who operates a fourth terminal apparatus in accordance with audio data corresponding to sound collected by the fourth terminal apparatus, the audio data being received by the server apparatus through the communicator, the fourth terminal apparatus being one of the plurality of terminal apparatuses, the fourth terminal apparatus being a terminal apparatus to which a third authority is set, the third authority being one of authorities that are preliminarily set in the teleconference and being authority of a higher level than the first authority and a lower level than the second authority; and
wherein the first determining operation further comprises:
when the total number of the plurality of terminal apparatuses is larger than a second value that is larger than the first value, determining, as the transmission destination of the first notification, the fourth terminal apparatus for which the speaking state detected by the first detecting operation is speaking.

4. The storage medium according to claim 3, wherein the first determining operation further comprises:
when the total number of the plurality of terminal apparatuses is larger than the first value and smaller than the second value, determining the fourth terminal apparatus as the transmission destination of the first notification regardless of the speaking state of the fourth terminal apparatus.

5. The storage medium according to claim 1, wherein the program further causes, when executed, the server apparatus to perform operations comprising:
a second receiving operation of receiving a second notification different from the first notification, through the communicator, from the first terminal apparatus;
a second determining operation of determining a third terminal apparatus as the transmission destination of the second notification received by the second receiving operation without determining a second terminal apparatus as the transmission destination of the second notification, the second terminal apparatus being one of the plurality of terminal apparatuses, the second terminal apparatus being a terminal apparatus to which the first authority is set and being different from the first terminal apparatus, the third terminal apparatus being one of the plurality of terminal apparatuses, the third terminal apparatus being a terminal apparatus to which a second authority is set, the second authority being one of authorities that are preliminarily set in the teleconference and being authority of a higher level than the first authority; and
a second transmitting operation of transmitting the second notification from the communicator to the transmission destination determined by the second determining operation.

6. The storage medium according to claim 5, wherein the program further causes, when executed, the server apparatus to perform operations comprising:
a second detecting operation of detecting a speaking state of a user who operates the third terminal apparatus in accordance with audio data corresponding to sound collected by the third terminal apparatus, the audio data being received by the server apparatus through the communicator; and
wherein the second determining operation comprises:
determining whether the third terminal apparatus includes a non-speaking third terminal apparatus for which the speaking state detected by the second detecting operation is not speaking; and
when the third terminal apparatus includes the non-speaking third terminal apparatus, determining the non-speaking third terminal apparatus as the transmission destination of the second notification. 7. The storage medium according to claim 6, wherein the second determining operation further comprises:
when the speaking state detected by the second detecting operation is speaking for all of the third terminal apparatus included in the plurality of terminal apparatuses, determining the all of the third terminal apparatus as the transmission destination of the second notification.

8. The storage medium according to claim 2, wherein the program further causes, when executed, the server apparatus to perform operations comprising:
a third receiving operation of receiving a third notification through the communicator from the third terminal apparatus, the third notification being different from the first notification and being a response to the first notification; and
an updating operation of, when the third notification is received by the third receiving operation, updating audio setting for audio data corresponding to sound collected by the first terminal apparatus.

9. The storage medium according to claim 8, wherein the third receiving operation comprises receiving, as the third notification, a positive third notification of permitting transmission of audio data corresponding to sound collected by the first terminal apparatus and a negative third notification of not permitting transmission of the audio data corresponding to the sound collected by the first terminal apparatus; and
wherein the updating operation comprises:
when the positive third notification is received by the third receiving operation, setting the audio setting to a state of permitting transmission of the audio data corresponding to the sound collected by the first terminal apparatus; and
when the negative third notification is received by the third receiving operation, setting the audio setting to a state of not permitting transmission of the audio data corresponding to the sound collected by the first terminal apparatus.

10. The storage medium according to claim 8, wherein the program further causes, when executed, the server apparatus to perform operations comprising:
a third transmitting operation of, when the audio setting is updated, transmitting a fourth notification from the communicator to the transmission destination determined by the first determining operation, the fourth notification being indicative of cancellation of a state obtained in response to the first notification.

11. The storage medium according to claim 5, wherein the program further causes, when executed, the server apparatus to perform operations comprising:
a fourth receiving operation of receiving a fifth notification through the communicator from the third terminal apparatus, the fifth notification being a response to the second notification;
a chat operation of, when the fifth notification is received by the fourth receiving operation, executing, through the communicator, a chat process including real-time communication of character data between the first terminal apparatus and the third terminal apparatus that is the transmission source of the fifth notification; and
a fourth transmitting operation of, when the chat process is started by the chat operation, transmitting a sixth notification from the communicator to the transmission destination determined by the second determining operation, the sixth notification being indicative of cancellation of a state obtained in response to the second notification.

12. A server apparatus configured to execute a teleconference conducted by a plurality of terminal apparatuses connected to a network, the server apparatus comprising:
a communicator configured to connect to the network;
a processor; and
a memory storing instructions, the instructions, when executed by the processor, causing the processor to perform:
a first receiving operation of receiving a first notification, through the communicator, from a first terminal apparatus out of the plurality of terminal apparatuses, a first authority being set to the first terminal apparatus, the first authority being one of authorities that are preliminarily set in the teleconference;
a first determining operation of determining a transmission destination of the first notification received by the first receiving operation based on conference mode information related to a total number of the plurality of terminal apparatuses connecting to the teleconference, the transmission destination being at least one of the plurality of terminal apparatuses; and
a first transmitting operation of transmitting the first notification from the communicator to the transmission destination determined by the first determining operation.

13. A method of controlling a server apparatus configured to execute a teleconference conducted by a plurality of terminal apparatuses connected to a network, the method comprising:
receiving a first notification, through a communicator of the server apparatus connected to the network, from a first terminal apparatus out of the plurality of terminal apparatuses, a first authority being set to the first terminal apparatus, the first authority being one of authorities that are preliminarily set in the teleconference;
determining a transmission destination of the first notification based on conference mode information related to a total number of the plurality of terminal apparatuses connecting to the teleconference, the transmission destination being at least one of the plurality of terminal apparatuses; and
transmitting the first notification from the communicator to the determined transmission destination.
